(19) United States
(12) Patent Application Publication
(10) Pub. No.: US 2015/0095575 A1
(43) Pub. Date: Apr. 2, 2015

(54) CACHE MIGRATION MANAGEMENT METHOD AND HOST SYSTEM APPLYING THE METHOD

(71) Applicant: SAMSUNG ELECTRONICS CO., LTD., Suwon-si (KR)

(72) Inventors: Sang-jin OH, Suwon-si (KR); Jong-Tae PARK, Seoul (KR); Sung-chul KIM, Hwaseong-si (KR)

(73) Assignee: SAMSUNG ELECTRONICS CO., LTD., Suwon-si (KR)

(21) Appl. No.: 14/501,916

(22) Filed: Sep. 30, 2014

(30) Foreign Application Priority Data
Sep. 30, 2013 (KR) 10-2013-0116890

(51) Int. Cl. G06F 12/08

(52) U.S. Cl. CPC G06F 12/0802
USPC 711/118

(57) ABSTRACT

Provided are a cache migration management method and a host system configured to perform the cache migration management method. The cache migration management method includes: moving, in response to a request for cache migration with respect to first data stored in a main storage device, the first data and second data related to the first data from the main storage device to a cache storage device; and adding information about the first data moved to the cache storage device and the second data moved to the cache storage device, the moving of the first data and the second data to the cache storage device including storing the first data moved to the cache storage device and the second data moved to the cache storage device at continuous physical addresses of the cache storage device in an order in which the first data and the second data are to be loaded to a host device.

### CROSS-REFERENCE TO RELATED APPLICATION

This application claims priority from Korean Patent Application No. 10-2013-0116890, filed on Sep. 30, 2013, in the Korean Intellectual Property Office, the disclosure of which is incorporated herein in its entirety by reference.

### BACKGROUND

1. Field

The exemplary embodiments disclosed herein relate to a host system and a data processing method, and more particularly, to a cache migration management method and a host system applying the method.

2. Description of the Related Art

In general, a host system uses a hard disk drive as a main storage unit. However, although a hard disk drive is less expensive than a semiconductor memory device, a hard disk drive has a lower access speed. To address this drawback, a host system uses a cache memory device to improve access speed. System performance may be influenced by a cache management method of a host system that uses a cache storage device. Accordingly, research into a cache management method for improving the performance of a host system is actively being conducted.

### SUMMARY

The exemplary embodiments provide a cache migration management method in which a cache migration operation is performed in consideration of relationships between data, which are objects of cache migration.

The exemplary embodiments also provide a storage system for performing cache migration in consideration of relationships between data, which are objects of cache migration.

According to an aspect of an exemplary embodiment, there is provided a cache memory management method including: moving, in response to a request for cache migration with respect to first data stored in a main storage device, the first data and second data related to the first data from the main storage device to a cache storage device; and adding information about the first data moved to the cache storage device and the second data moved to the cache storage device, wherein the moving of the first data and the second data to the cache storage device includes storing the first data moved to the cache storage device and the second data moved to the cache storage device at continuous physical addresses of the cache storage device in an order in which the first data and the second data are to be loaded to a host device.

The moving of the first data and the second data to the cache storage device may include adjusting a writing position such that start positions of the first data and the second data are aligned with a page start position of the cache storage device.

The first data and the second data may include file data belonging to a same program installed in the host device.

The method may further include generating the request for the cache migration based on an access frequency with respect to the first data stored in the main storage device.

The cache memory management method may further include reading third data and fourth data related to the third data based on access frequencies of the third data, the third data and the fourth data being stored in the cache storage device, and storing the third data and the fourth data in an initially allocated cache area of the host device.

The cache memory management method may further include, in response to generating a request for reading fifth data from among data stored in the cache storage device, reading the fifth data and sixth data related to the fifth data from the cache storage device and storing the fifth data and the sixth data in an initially allocated cache area of the host device.

The storing may include storing, in the cache table, a logical address of the first data and the second data stored in the cache storage device and a physical address of the cache storage device.

According to another aspect of an exemplary embodiment, there is provided a host system including: a main storage device configured to store data; a host memory configured to store the data when the data is read from the main storage device; and a central processor configured to migrate first data and second data related to the first data, among the data stored in the main storage device, from the main storage device to a cache area of the host memory, based on a request for cache migration with respect to the first data, according to an access order indicating an order in which the first data and the second data are to be loaded to the host memory.

In response to a request for reading the first data and the second data stored in the cache area of the host memory, the central processor is configured to perform an operation of reading the first data and the second data from the cache area of the host memory.

The host system may further include a cache storage device configured to store data selected from among data stored in the main storage device, wherein, in response to the request for the cache migration with respect to the first data stored in the main storage device, the central processor is configured to perform an operation of moving the first data and the second data related to the first data, from the main storage device to continuous physical addresses of the cache storage device.

The main storage device and the cache storage device may include non-volatile storage devices, and the cache storage device may have a higher access speed than an access speed of the main storage device.

The main storage device may include a hard disk drive, and the cache storage device may include a solid state drive.

The central processor may be configured to adjust a writing position such that a start position of the first data and a start position of the second data are aligned with a page start position of the cache storage device.

The central processor may be configured to perform an operation of reading third data and fourth data related to the third data based on an access frequency of the third data, the third data and the fourth data being stored in the cache storage device, and may be configured to store the third data and the fourth data in an initially allocated cache area of the host memory.

In response to a request for reading fifth data from among the data stored in the cache storage device being generated, the central processor may be configured to perform an operation of reading the fifth data and sixth data related to the fifth data from the cache storage device and storing the fifth data and the sixth data in an initially allocated cache area of a host memory.

### BRIEF DESCRIPTION OF THE DRAWINGS

Exemplary embodiments of the disclosure will be more clearly understood from the following detailed description taken in conjunction with the accompanying drawings in which:

FIG. 1 is a block structural diagram illustrating a host system according to an exemplary embodiment;

FIG. 2 is a block structural diagram illustrating a host system according to another exemplary embodiment;

FIGS. 3A and 3B illustrate allocation of a storage area of the host memory illustrated in FIG. 1 or 2 according to exemplary embodiments;

FIGS. 4A through 4C illustrate various programs and various types of data stored in the host memory illustrated in FIG. 1 or 2 according to exemplary embodiments;

FIG. 5A illustrates positions of data stored in a cache storage device when cache migration is performed without considering relationships between data, which are objects of cache migration;

FIG. 5B illustrates positions of data stored in a cache storage device when cache migration is performed in a host system according to an exemplary embodiment;

FIG. 6A illustrates positions of data stored in a cache storage device when page alignment adjustment is not performed during cache migration;

FIG. 6B illustrates positions of data stored in a cache storage device when page alignment adjustment is performed during cache migration according to an exemplary embodiment;

FIG. 7 is a view illustrating programs installed in a host device and sizes of the programs;

FIG. 8 is a conceptual diagram for explaining an example of a method of performing cache migration in a host system according to an exemplary embodiment;

FIG. 9 is a conceptual diagram for explaining an example of a method of performing cache migration in a host system according to another exemplary embodiment;

FIG. 10 is a conceptual diagram for explaining an example of a method of performing cache migration in a host system according to another exemplary embodiment;

FIG. 11 illustrates details of the main storage device illustrated in FIG. 1 or 2 according to an exemplary embodiment;

FIG. 12 illustrates a detailed structure of the head disk assembly (HDA) illustrated in FIG. 11 according to an exemplary embodiment;

FIG. 13 illustrates details of the cache storage device illustrated in FIG. 1 according to an exemplary embodiment;

FIG. 14 illustrates a detailed structure of the cache storage device of FIG. 1 according to an exemplary embodiment;

FIG. 15 illustrates a detailed structure of the cache storage device of FIG. 1 according to another exemplary embodiment

FIG. 16 illustrates channels and ways of the cache storage device illustrated in FIG. 15 according to an exemplary embodiment;

FIG. 17 illustrates a detailed structure of a flash memory chip included in the memory device illustrated in FIGS. 14 and 15 according to an exemplary embodiment;

FIG. 18 is a cross-sectional view illustrating details of the memory cell array illustrated in FIG. 17 according to an exemplary embodiment;

FIG. 19 is a conceptual diagram illustrating an internal storage structure of a flash memory chip according to an exemplary embodiment;

FIG. 20 is a flowchart of a cache migration management method according to an exemplary embodiment;

FIG. 21 is a detailed flowchart of the operation of moving data to a cache storage device illustrated in FIG. 20 according to an exemplary embodiment;

FIG. 22 is a flowchart of an operation of performing cache migration to a cache area of a host memory according to an exemplary embodiment;

FIG. 23 is a flowchart of an operation of performing cache migration to a cache area of a host memory according to another exemplary embodiment;

FIG. 24 is a flowchart of a cache migration management method according to another exemplary embodiment;

FIG. 25 is a flowchart of a reading operation to be performed by a host system according to an exemplary embodiment;

FIG. 26 is a flowchart of a reading operation to be performed by a host system according to another exemplary embodiment;

FIG. 27 is a flowchart of a reading operation to be performed by a host system according to yet another exemplary embodiment of the inventive concept;

FIG. 28 is a block diagram illustrating an electronic device configured to perform a cache migration management method according to exemplary embodiments; and

FIG. 29 is a block diagram illustrating a network system including a server system configured to perform a cache migration management method according to exemplary embodiments.

### DETAILED DESCRIPTION OF THE EXEMPLARY EMBODIMENTS

Hereinafter, the exemplary embodiments will be described more fully with reference to the accompanying drawings, in which exemplary embodiments are shown. However, these exemplary embodiments are provided so that this disclosure will be thorough and complete to those of ordinary skill in the art. As the exemplary embodiments allow for various changes and many different forms, particular exemplary embodiments will be illustrated in the drawings and described in detail in the written description. However, this is not intended to limit the exemplary embodiments to particular modes of practice, and it is to be appreciated that all changes, equivalents, and substitutes that do not depart from the spirit and technical scope of the exemplary embodiments are encompassed in the exemplary embodiments. Like reference numerals in the drawings denote like elements. In the drawings, measurements of elements are expanded or reduced for clarity of the exemplary embodiments.

The terms used in the present specification are merely used to describe particular exemplary embodiments, and are not intended to limit the exemplary embodiments. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. As used herein, the term “and/or” includes any and all combinations of one or more of the associated listed items.

Unless defined differently, all terms used in the description including technical and scientific terms have the same meaning as generally understood by those skilled in the art. Terms as defined in a commonly used dictionary should be construed as having the same meaning as in an associated technical context, and unless defined apparently in the description, the terms are not ideally or excessively construed as having formal meaning.

As used herein, the term “and/or” includes any and all combinations of one or more of the associated listed items. Expressions such as “at least one of,” when preceding a list of elements, modify the entire list of elements and do not modify the individual elements of the list.

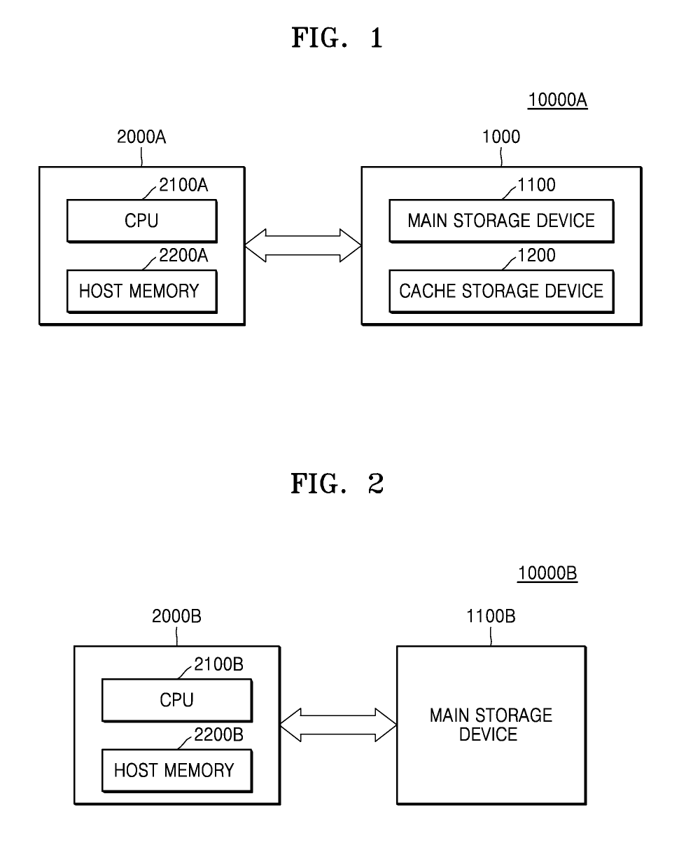

FIG. 1 is a block structural diagram illustrating a host system 10000A according to an exemplary embodiment.

As illustrated in FIG. 1, the host system 10000A includes a storage device 1000 and a host device 2000A.

The storage device 1000 includes a main storage device 1100 and a cache storage device 1200. The storage device 1000 performs a reading or writing operation according to a command transmitted from the host device 2000A.

The main storage device 1100 and the cache storage device 1200 may be implemented as non-volatile storage devices, although are not limited thereto. Also, the cache storage device 1200 may be a storage device with a higher access speed than the main storage device 1100.

For example, the main storage device 1100 may be a hard disk drive (HDD), and the cache storage device 1200 may be a solid state drive (SSD). Alternatively, the cache storage device 1200 may be other types of non-volatile memory-based storage devices such as a universal serial bus (USB) memory or a memory card.

The host device 2000A includes a central processing unit (CPU) 2100A (e.g., central processor) and a host memory 2200A. Examples of the host device 2000A may include electronic devices such as a computer, a mobile phone, a personal digital assistant (PDA), a portable multimedia player (PMP), an MP3 player, a camera, and a camcorder.

The CPU 2100A is a processor that controls the overall operation of the host system 10000A. The host memory 2200A is a memory of the host device 2000A and may be a dynamic random access memory (DRAM) or a static random access memory (SRAM). The host memory 2200A performs a reading or writing operation according to control of the CPU 2100A.

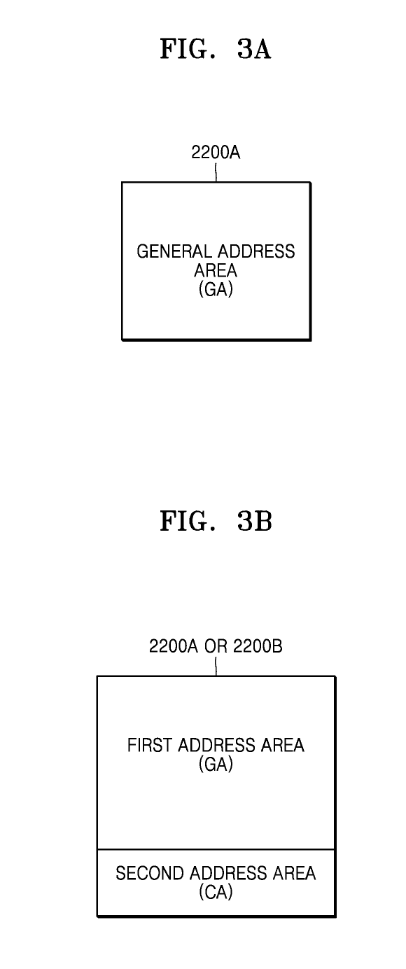

FIGS. 3A and 3B illustrate allocation of a storage area of the host memory illustrated in FIG. 1 or 2 according to exemplary embodiments.

As illustrated in FIG. 3A, for example, the entire storage area of the host memory 2200A may be allocated as a general address area GA. Host data or programs may be stored in an area designated by an arbitrary address in the entire storage area allocated as the general address area GA.

Alternatively, a portion of the storage area of the host memory 2200A may be allocated as a reserved area. This allocated reserved area may be set as a cache area CA. As illustrated in FIG. 3B, a first address area of the storage area of the host memory 2200A may be allocated as a general address area GA, and a second address area may be allocated as a cache area CA.

Upon a request for cache migration with respect to first data stored in the main storage device 1100, the CPU 2100 performs an operation of moving the first data and second data related to the first data from the main storage device 1100 to areas designated by continuous physical addresses in the cache storage device 1200 based on an access order. That is, the CPU 2100A performs an operation of moving first data and second data to continuous physical addresses from the main storage device 1100 to the cache storage device 1200 in an order in which the first data and the second data are to be loaded to the host device 2000A.

For example, the second data may include at least one piece of file data related to the first data. If there is no data related to the first data, an operation of moving the first data to the cache storage device 1200 is performed.

For example, when the cache storage device 1200 is an SSD, page alignment may be performed such that a start position of data to be written in accordance with cache migration is aligned with a page start position of a flash memory which is used as a memory device of the SSD.

For example, page alignment may be performed by determining page size information of the cache storage device 1200 by using a vendor unique command. Alternatively, page alignment may be performed using an ID table in which page size information is recorded.

For example, a request for cache migration is generated when a condition is detected as being satisfied for pre-storing, in the cache storage device 1200, files which are among the programs stored in the host device 2000A and are frequently accessed. A request for cache migration may be generated based on a user's selection. A request for cache migration may also be generated when the host system 10000A is in an idle state.

For example, first and second data which are moved to the cache storage device 1200 according to cache migration may include file data belonging to the same program installed in the host device 2000A.

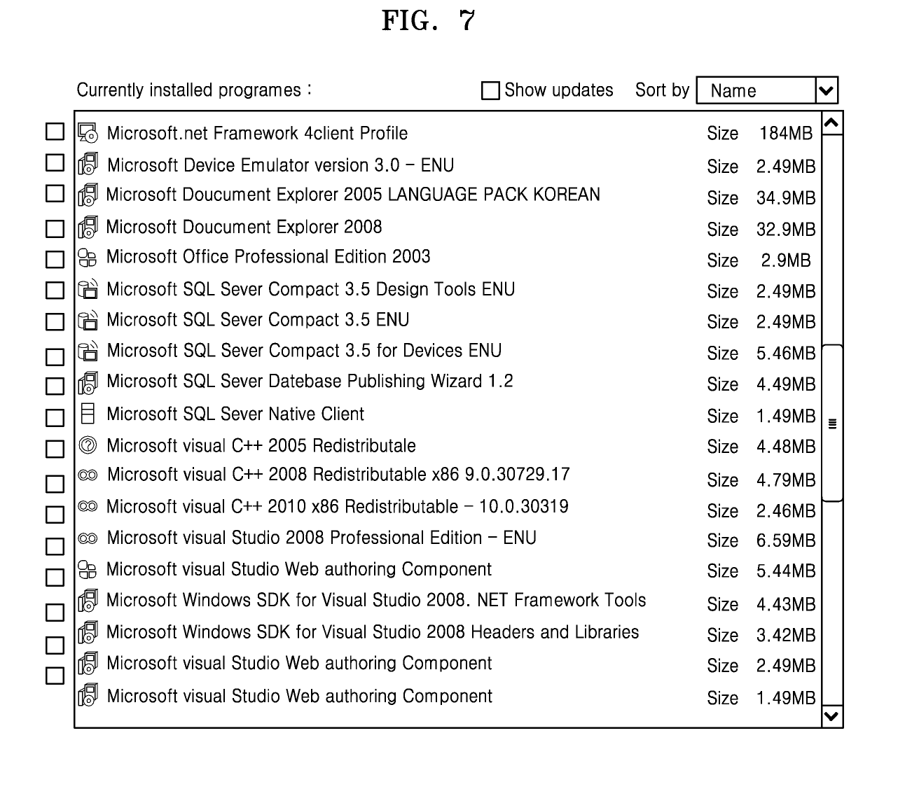

FIG. 7 is a view illustrating programs installed in a host device and sizes of the programs.

For example, the CPU 2100A may assign IDs to respective programs, and when a predetermined file is requested, the CPU 2100A performs an operation of moving files having the same ID from the main storage device 1100 to continuous physical addresses of the cache storage device 1200 based on an access order of the files. For reference, the CPU 2100A may be aware of programs installed in the host device 2000A and sizes of the programs as illustrated in FIG. 7. Also, the CPU 2100A may be aware of files respectively belonging to the programs installed in the host device 2000A.

For example, when a cache area is set in the host memory 2200A, the CPU 2100A performs operations of reading third data having an access frequency higher than a reference value and fourth data related to the third data, and storing the third data and the fourth data in the cache area of the host memory 2200A. For example, the fourth data may include at least one piece of file data related to the third data. If there is no data related to the third data, the CPU 2100A performs an operation of moving the third data to the cache area of the host memory 2200A.

Alternatively, upon a request for reading fifth data from among data stored in the cache storage device 1200, the CPU 2100A performs operations of reading the fifth data and sixth data related to the fifth data from the cache storage device 1200 and storing the fifth data and the sixth data in the cache area of the host memory 2200A. For example, the sixth data may include at least one piece of file data related to the fifth data. If there is no data related to the fifth data, an operation of moving the fifth data to the cache area of the host memory 2200A is performed.

FIG. 2 is a block structural diagram illustrating a host system 10000B according to another exemplary embodiment.

As illustrated in FIG. 2, the host system 10000B includes a main storage device 1100B and a host device 2000B.

The main storage device 1100B performs a reading or writing operation according to a command transmitted from the host device 2000B. The main storage device 1100B may be implemented as a non-volatile storage device, although is not limited thereto. For example, the main storage device 1100B may be an HDD or a SSD.

The host device 2000B includes a CPU 2100B and a host memory 2200B. Examples of the host device 2000A include electronic devices such as a computer, a mobile phone, a PDA, a PMP, a MP3 player, a camera, and a camcorder. It is understood that many other types of electronic devices, such as tablets, gaming systems, etc., may also be implemented as the host device in accordance with exemplary embodiments.

The CPU 2100B is a processor that controls the overall operation of the host system 10000B. The host memory 2200B is a memory of the host device 2000B and may be a DRAM or a SRAM.

The host memory 2200B performs a reading or writing operation according to control of the CPU 2100B. A portion of a storage area of the host memory 2200B is allocated as a reserved area. As illustrated in FIG. 3B, a first address area of the storage area of the host memory 2200B may be allocated as a general address area GA, and a second address area may be allocated as a cache area CA.

Upon a request for cache migration with respect to first data stored in the main storage device 1100B, the CPU 2100 perform operations of reading first data stored in the main storage device 1100B and second data related to the first data and continuously storing the first data and the second data in a cache area of the host memory 2200B according to an access order of the first and second data.

For example, a request for cache migration is generated when a condition is detected for pre-storing, in the host memory 2200B, files which are among the programs stored in the host device 2000B and are frequently accessed. A request for cache migration may also be generated based on a user's selection. A request for cache migration may further be generated when the host system 10000B is in an idle state.

For example, first and second data which are moved to the cache area of the host memory 2200B according to cache migration may include file data belonging to the same program installed in the host device 2000B.

For example, the CPU 2100B may assign IDs to respective programs, and when a predetermined file is requested, the CPU 2100B may perform operations of reading files having the same ID from the main storage device 1100B and continuously storing the same in the cache area of the host memory 2200B according to an access order of the files.

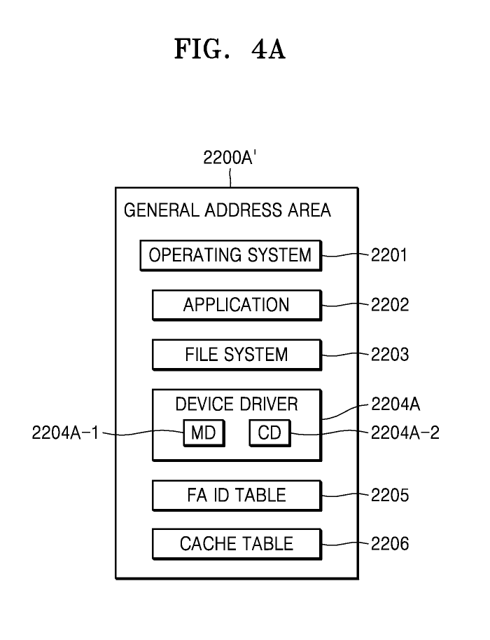

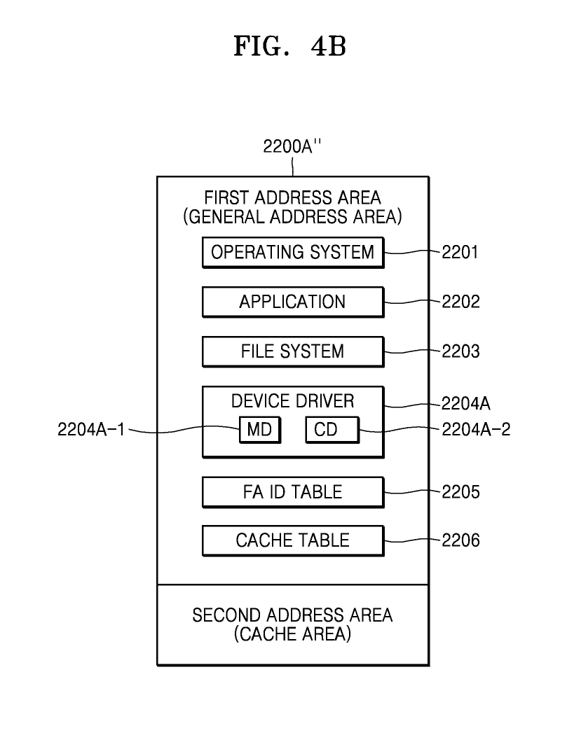

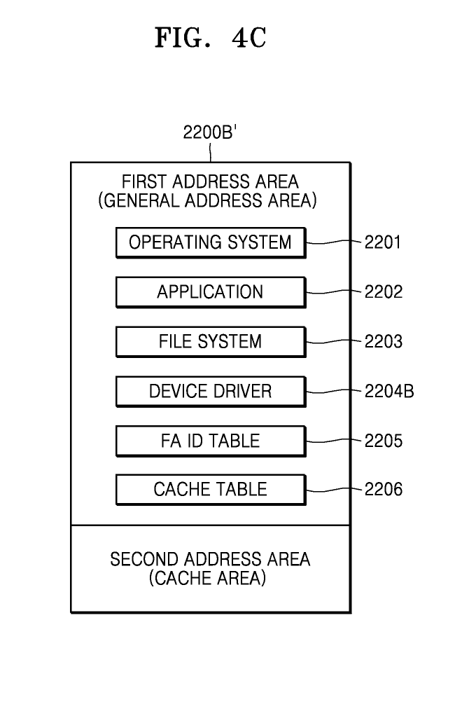

FIGS. 4A through 4C illustrate various programs and various types of data stored in the host memory illustrated in FIG. 1 or 2 according to exemplary embodiments.

FIG. 4A illustrates programs and data stored in a host memory 2200A′ which may be implemented into the host system 10000A of FIG. 1 according to an exemplary embodiment.

Referring to FIG. 4A, an operating system 2201, an application 2202, a file system 2203, a device driver 2204A, a file allocation (FA) ID table 2205, and a cache table 2206 may be stored in a general address area of the host memory 2200A′.

The operating system 2201 is a program for controlling hardware and software resources of the host device 2000A. The operating system 2201 functions as an interface between hardware and an application program and is configured to manage resources of the host system 10000A.

The application 2202 may be one or a plurality of various types of application programs to be executed in the host system 10000A. For example, various programs, for example, programs that support an operation of processing a file or data, an operation of calculating an access frequency of data stored in the storage device 1000 or a cache migration operation, may be included in the application 2202. Also, a program for adjusting a writing/reading position such that a start position of data to be written to the cache storage device 1200 is aligned with a page start position of the cache storage device 1200 may be included. Alternatively, programs that support access frequency calculation or cache migration may be included in one of the operating system 2201, the file system 2203, and the device driver 2204A, besides the application 2202. Alternatively, programs that support access frequency calculation and cache migration may be installed in another layer.

The file system 2203 is a program that manages a logic storage position for storing or retrieving a file or data in the host memory 2200A′ or the storage device 1000.

The device driver 2204A includes a main storage device driver (MD) 2204A-1 and a cache storage device driver (CD) 2204A-2.

The main storage device driver 2204A-1 is a program supporting communication between the host device 2000A and the main storage device 1100, and the cache storage device driver 2204A-2 is a program supporting communication between the host device 2000A and the cache storage device 1200.

The FA ID table 2205 stores information indicating related pieces of data which are assigned to the same ID and an order in which the file data under the same ID is to be accessed in a host device.

The cache table 2206 stores information related to data moved to the cache storage device 1200 by cache migration. For example, in the cache table 2206, logic addresses of data moved to the cache storage device 1200 and physical addresses of the data stored in the cache storage device 1200 may be stored.

An example of implementing the host memory 2200A′ illustrated in FIG. 4A into the host system 10000A of FIG. 1 will be described below.

The CPU 2100A may perform cache migration according to exemplary embodiments by operating programs that support calculating an access frequency indicating a frequency at which data stored in the storage device 1000 is accessed and cache migration.

For example, the CPU 2100A generates a request for cache migration when first data having an access frequency that is higher than a reference value is detected as a result of access frequency calculation. The CPU 2100A retrieves second data related to the first data by using the FA ID table 2205 based on the request for cache migration with respect to the first data. The CPU 2100A issues a command for performing cache migration whereby the first data and the second data related to the first data are moved from the main storage device 1100 to continuous physical addresses of the cache storage device 1200 based on an access order of the first and second data.

When a command for performing cache migration is issued as described above, the CPU 2100A operates the programs of the main storage device driver MD 2204-1 and the cache storage device driver CD 2204A-2. Then, the first and second data is read from the main storage device 1100 according to a command for performing migration to perform an operation of writing the first and second data to continuous physical addresses of the cache storage device 1200 based on an access order. The CPU 2100A may adjust a writing position such that a start position of data to be written to the cache storage device 1200 is aligned with a page start position of the cache storage device 1200.

After writing the first and second data to the cache storage device 1200 according to cache migration, logical addresses of the first and second data and a physical address of the cache storage device 1200 are stored in the cache table 2206.

FIG. 4B illustrates programs and data stored in a host memory 2200A′ that may be implemented into the host system 10000A of FIG. 1 according to another exemplary embodiment.

Referring to FIG. 4B, an operating system 2201, an application 2202, a file system 2203, a device driver 2204A, an FA ID table 2205, and a cache table 2206 may be stored in a general address area of the host memory 2200A″.

The host memory 2200A″ is different from the host memory 2200A′ of FIG. 4A in that a second address area allocated as a reserved area is included in the host memory 2200A″. The second address area is designated as a cache area.

Programs and data stored in the general address area of the host memory 2200A″ have been described above with reference to FIG. 4A, and thus, a repeated description thereof will be omitted.

An example of implementing the host memory 2200A″ illustrated in FIG. 4B into the host system 10000A of FIG. 1 will be described below.

The operation of moving first data and second data related to the first data according to cache migration using the programs and data stored in the general address area of the host memory 2200A″ from the main storage device 1100 to the cache storage device 1200 has been described above in detail, and thus, a repeated description thereof will be omitted.

By using the programs and data stored in the general address area of the host memory 2200A″, the CPU 2100A performs operations of reading third data having a relatively high access frequency and fourth data related to the third data, based on access frequencies of data stored in the cache storage device 1200, and writing the third data and the fourth data to the cache area of the host memory 2200A″. After writing the third data and the fourth data to the cache area of the host memory 2200A″, the CPU 2100A stores a logical address of the third data and the fourth data and a physical address of the host memory 2200A″ in the cache table 2206.

Accordingly, information about data moved to the cache storage device 1200 or to the cache area of the host memory 2200A″ is stored in the cache table 2206. Every time the host system 10000A is initialized, information about the data moved to the cache area of the host memory 2200A″ from among information stored in the cache table 2206 is deleted. For example, an area for storing information about data stored in the cache area of the host memory 2200A″ may be separately designated and controlled in the cache table 2206.

FIG. 4C illustrates various programs and data stored in the host memory 2200B′ that may be implemented into the host system 10000B of FIG. 2 according to another exemplary embodiment.

Referring to FIG. 4C, an operating system 2201, an application 2202, a file system 2203, a device driver 2204B, an FA ID table 2205, and a cache table 2206 may be stored in a general address area of the host memory 2200B′.

The host memory 2200B′ is different from the host memory 2200A″ of FIG. 4B with respect to the device driver 2204B. That is, while the device driver 2204A of FIG. 4B includes the main storage device driver (MD) 2204A-1 and the cache storage device driver (CD) 2204A-2, the device driver of FIG. 4C 2204B includes only a driver of a main storage device.

For example, the application 2202 illustrated in FIG. 4C indicates various application programs executed in a host system. For example, programs that support processing files or data, or access frequency calculation and cache migration with respect to data stored in the storage device 1000, may be included in the application 2202. Alternatively, programs that support access frequency calculation or cache migration may be included in one of the operating system 2201, the file system 2203, and the device driver 2204A, besides the application 2202. Alternatively, programs that support access frequency calculation and cache migration may be installed in another layer.

An example of implementing the host memory 2200B′ illustrated in FIG. 4C into the host system 10000B of FIG. 2 will be described below.

The CPU 2100B may perform cache migration according to the exemplary embodiments by operating the programs that support access frequency calculation and cache migration with respect to data stored in the main storage device 1100B.

For example, the CPU 2100B generates a request for cache migration when first data having an access frequency that is higher than a reference value is detected as a result of access frequency calculation. The CPU 2100B retrieves second data related to the first data by using the FA ID table 2205 based on the request for cache migration with respect to the first data. The CPU 2100B issues a command for performing cache migration whereby the first data and the second data related to the first data which are grouped under the same ID are read from the main storage device 1100B based on an access order thereof and are continuously stored in the cache area of the host memory 2200B′ according to the access order.

When a command for performing cache migration is issued as described above, the CPU 2100B operates programs of the device driver 2204B. Then, the CPU 2100B performs an operation of reading the first and second data from the main storage device 1100B according to a command for performing migration and continuously writing the first and second data to the cache area of the host memory 2200B′ based on the access order.

After writing the first and second data to the cache area of the host memory 2200B′ according to cache migration, the CPU 2100B stores logical addresses of the first and second data and a physical address of the cache area of the host memory 2200B′ in the cache table 2206. Every time the host system 10000B is initialized, information stored in the cache table 2206 is deleted.

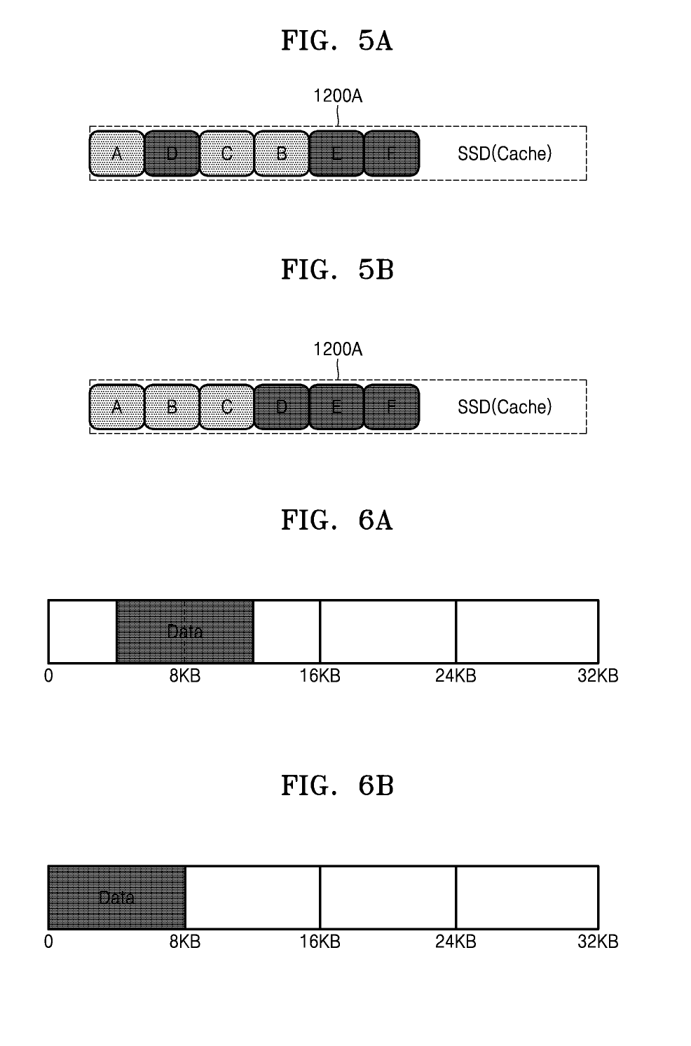

FIG. 5A illustrates positions of data stored in a cache storage device when cache migration is performed without considering relationships between data, which are objects of migration.

FIG. 5B illustrates positions of data stored in a cache storage device when cache migration is performed in a host system according to an exemplary embodiment.

In FIGS. 5A and 5B, data A, B, and C are data related to one another, and data D, E, and F are data related to one another. For example, the data A, B, and C belong to one program, and the data D, E, and F belong to another program.

Referring to FIG. 5A, if cache migration is performed without considering relationships between data, pieces of related data are stored sporadically throughout the cache storage device. Thus, a time period necessary for reading relevant data stored in the cache storage device increases.

Referring to FIG. 5B, if cache migration is performed by considering relationships between data, related data may be continuously stored in the cache storage device. Accordingly, a time period necessary for reading relevant data stored in the cache storage device may be reduced.

FIG. 6A illustrates positions of data stored in a cache storage device when page alignment adjustment is not performed during cache migration.

FIG. 6B illustrates positions of data stored in a cache storage device when page alignment adjustment is performed during cache migration according to an exemplary embodiment.

If adjustment of page alignment of a page stored in a cache storage device is not performed when performing cache migration, a start address of data and a start position of the page may not be consistent, as illustrated in FIG. 6A.

Referring to FIG. 6A, when performing cache migration, one page of data may be written to two pages of the cache storage device. In addition, when reading corresponding data, two pages may be read instead of one.

By performing page alignment adjustment in the cache storage device during cache migration, a start address of data and a start position of a page may be consistent with each other, as illustrated in FIG. 6B.

Referring to FIG. 6B, when performing cache migration, one page of data may be accurately written to one page of the cache storage device. Also, when reading corresponding data, a reading operation with respect to one page may be performed.

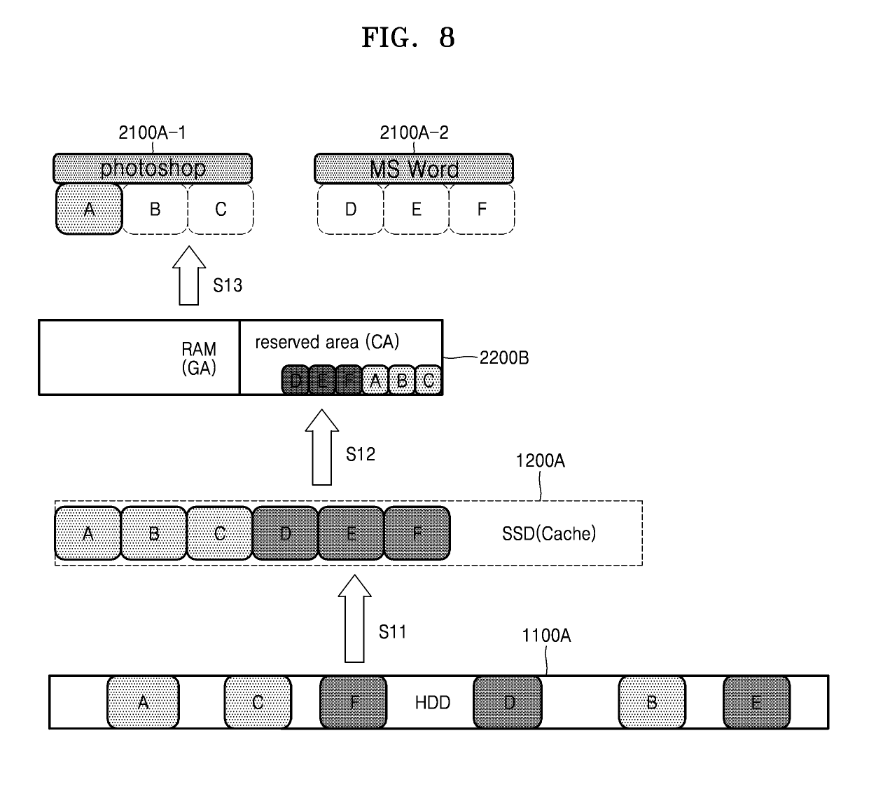

FIGS. 8 through 10 are conceptual diagrams for explaining examples of a method of performing cache migration in the host system 10000A or 10000B of FIG. 1 or 2 according to exemplary embodiments.

In FIGS. 8 through 10, an HDD 1100A is used as the main storage device 1100 of the host system, an SSD 1200A is used as the cache storage device 1200, and a RAM is used as the host memory. However, it is understood that the exemplary embodiments are not limited thereto.

A method of performing cache migration in the host system 10000A of FIG. 1 according to an exemplary embodiment will be described with reference to FIG. 8 below.

In the HDD 1100A, data is sporadically stored. For example, file data A, B, and C belonging to a Photoshop program 2100A-1 and file data D, E, and F belonging to an MS Word program 2100A-2 are stored in the HDD 1100A.

When, for example, a request for cache migration with respect to the file data A is generated in the host system 10000A, the CPU 2100A retrieves file data B and C of the Photoshop program 2100A-1, to which the file data A belongs, by using the FA ID table 2205. That is, data related to the file data A is indicated as being the file data B and C. Also, when the Photoshop program 2100A-1 is executed, an access order of the file data A, B, and C is checked.

The CPU 2100A also reads the file data B and C related to the file data A and writes the file data B and C to continuous physical addresses of the SSD 1200A based on an access order thereof in the host device 2000A in operation S11.

Likewise, if a request for cache migration with respect to the file data D is generated, the CPU 2100A of the host system 10000A also reads the file data E and F which are to be used in relation to the file data D, from the HDD 1100A, and writes the file data E and F to continuous physical addresses of the SSD 1200A in operation S11.

Accordingly, the file data A, B, and C belonging to the Photoshop program 2100A-1 are stored in continuous physical addresses in the SSD 1200A. Also, the file data D, E, and F belonging to the MS Word program 2100A-2 are also stored in continuous physical addresses of the SSD 1200A based on an access order.

Next, the CPU 2100A reads file data with respect to the Photoshop program 2100A-1 and the MS Word program 2100A-2 having an access frequency that is equal to or greater than a reference value, based on access frequency of data stored in the SSD 1200A, and writes the file data to the cache area CA of the RAM 2200B in operation S12.

Next, if a request for reading the file data of the Photoshop program 2100A-1 is generated in the host device 2000A, the CPU 2100A determines whether the file data A is stored in the cache area CA of the RAM 2200B. As a result of the determination, if the file data A for which reading is requested is stored in the cache area CA of the RAM 2200B, the file data A is read from the RAM 2200B and loaded to a position for executing the Photoshop program 2100A-1 of the host device 2000A in operation S13.

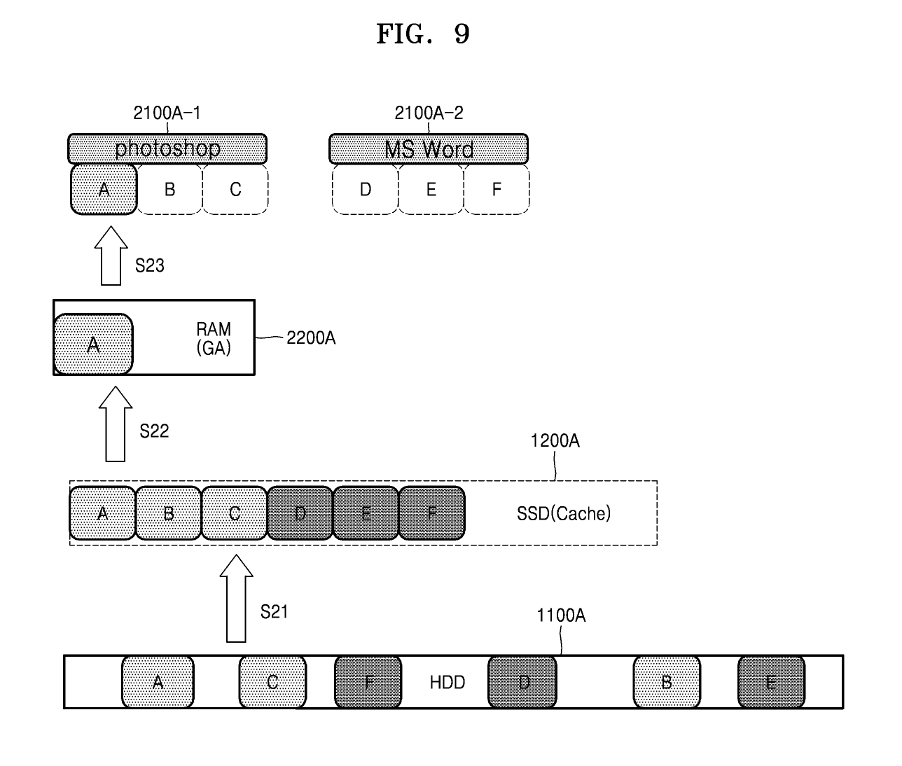

An example of a cache migration method in the host system 10000A of FIG. 1 according to another exemplary embodiment will be described below with reference to FIG. 9.

In the HDD 1100A, data is sporadically stored. For example, file data A, B, and C belonging to a Photoshop program 2100A-1 and file data D, E, and F belonging to an MS Word program 2100A-2 are stored throughout the HDD 1100A.

When a request for cache migration with respect to the file data A is generated in the host system 10000A, the CPU 2100A retrieves the file data B and C of the Photoshop program 2100A-1 to which the file data A belongs, by using the FA ID table 2205. Also, when the Photoshop program 2100A-1 is executed, an order in which file data A, B and C are to be accessed is checked.

The CPU 2100A of the host system 10000A also reads the file data B and C that are to be used in connection with the file data A and writes the file data B and C to continuous physical addresses of the SSD 1200A based on an access order of the file data A, B and C in the host device 2000A in operation S21.

Likewise, if a request for cache migration with respect to the file data D is generated, the CPU 2100A of the host system 10000A also reads the file data E and F which are to be used in connection with the file data D, from the HDD 1100A, and writes the file data E and F to continuous physical addresses of the SSD 1200A according to an access order in the host device 2000A in operation S21.

Accordingly, in the SSD 1200A, the file data A, B, and C belonging to the Photoshop program 2100A-1 are stored at the continuous physical addresses of the SSD 1200A based on an access order. Also, the file data D, E, and F belonging to the MS Word program 2100A-2 are also stored at the continuous physical addresses of the SSD 1200A.

Next, when a request for reading the file data A of the Photoshop program 2100A-1 is generated in the host device 2000A, the CPU 2100A determines whether the file data A is stored in the SSD 1200A. As a result of the determination, if the file data A for which reading is requested is stored in the SSD 1200A, the CPU 2100A reads the file data A from the SSD 1200A and writes the file data A to the RAM 2200A in operation S22.

Then, the file data A is read from the RAM 2200A and loaded at a position for executing the Photoshop program 2100A-1 of the host device 2000A in operation S23.

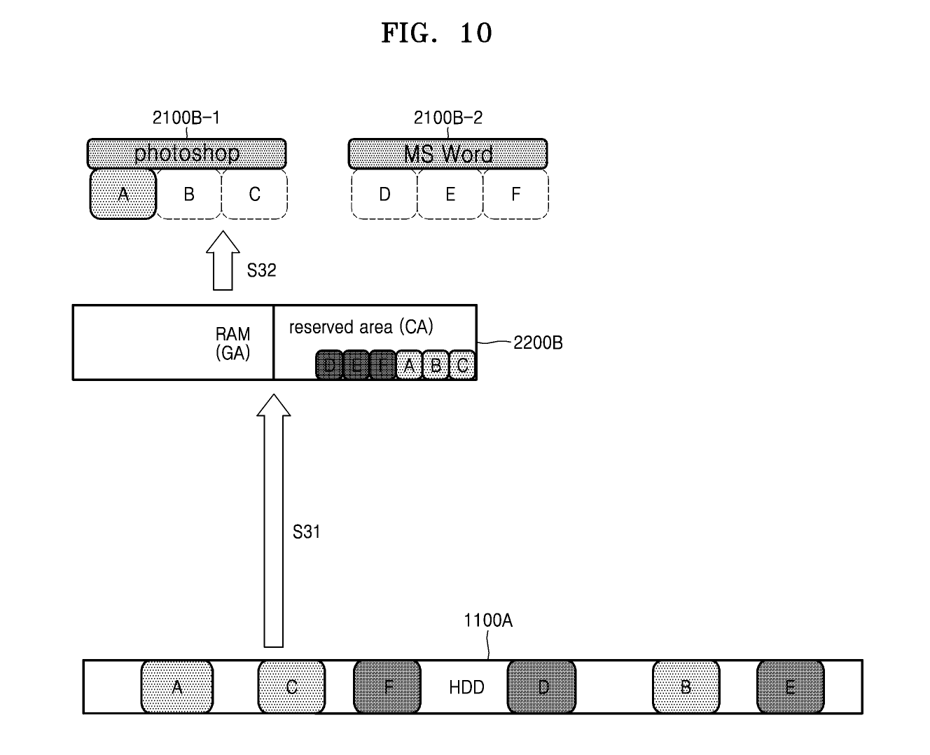

An example of a cache migration method in the host system 10000B of FIG. 2 according to another exemplary embodiment will be described below with reference to FIG. 10.

In the HDD 1100A, data is sporadically stored. For example, file data A, B, and C belonging to a Photoshop program 2100B-1 and file data D, E, and F belonging to an MS Word program 2100B-2 are stored in the HDD 1100A.

When a request for cache migration with respect to the file data A is generated in the host system 10000B, the CPU 2100B retrieves the file data B and C of the Photoshop program 2100B-1 to which the file data A belongs, by using the FA ID table 2205. Also, when the Photoshop program 2100B-1 is executed, an order in which the file data A, B, and C are to be accessed is checked.

The CPU 2100B of the host system 10000B also reads the file data B and C, that are to be used in connection with the file data A, from the HDD 1100A, and continuously writes the file data B and C to the cache area CA of the RAM 2200B based on an access order of the file data B and C in the host device 2000B in operation S31.

Likewise, if a request for cache migration with respect to file data D is generated, the CPU 2100B of the host system 10000B also reads the file data E and F which are to be used in connection with the file data D, from the HDD 1100A, and continuously writes the file data E and F to the cache area CA of the RAM 2200B in an access order in the host device 2000B in operation S31.

Accordingly, in the SSD 1200A, the file data A, B, and C belonging to the Photoshop program 2100B-1 are stored at continuous physical addresses of the cache area CA of the RAM 2200B based on the access order. Also, the file data D, E, and F belonging to the MS Word program 2100B-2 are also stored at continuous physical addresses of the cache area CA of the RAM 2200B.

Next, when a request for reading the file data A of the Photoshop program 2100B-1 is generated in the host device 2000B, the CPU 2100B determines whether the file data A is stored in the cache area CA of the RAM 2200B. If it is determined that the file data A for which reading is requested is stored in the cache area CA of the RAM 2200B, the CPU 2100A reads the file data A from the RAM 2200B and loads the file data A at a position for executing the Photoshop program 2100B-1 in operation S32.

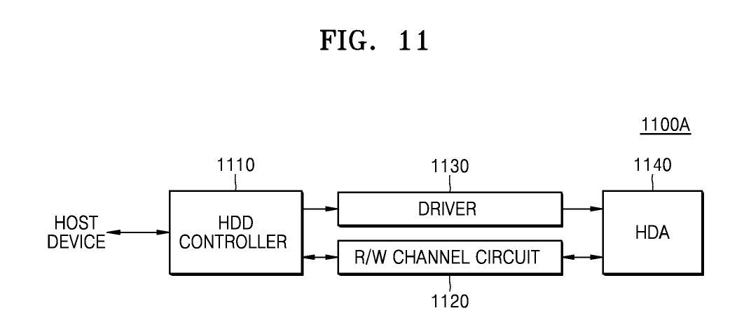

FIG. 11 illustrates the HDD 1100A implemented as the main storage device 1100 or 1100B, respectively illustrated in FIGS. 1 and 2.

As illustrated in FIG. 11, the HDD 1100A includes an HDD controller 1100, a read/write (R/W) channel circuit 1120, a driver 1130, and a head disk assembly (had) 1140.

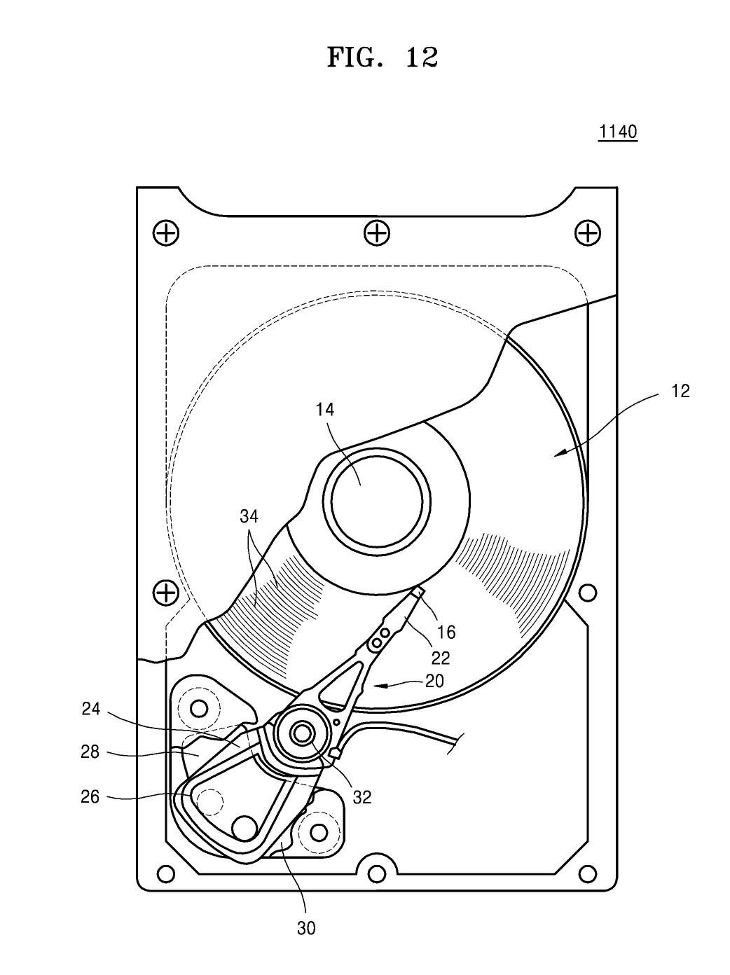

FIG. 12 illustrates a detailed structure of the HDA 1140 illustrated in FIG. 11 according to an exemplary embodiment.

Referring to FIG. 12, the HDA 1140 includes at least one magnetic disk 12 that rotates by using a spindle motor 14. The HDD 1100A also includes a converter 16 disposed adjacent to a surface of the magnetic disk 12.

The converter 16 may read or write information from or to the rotating magnetic disk 12 by sensing a magnetic field of the disk 12 or magnetizing the disk. The converter 16 is typically, although not necessarily, coupled to the surface of the disk 12. Although one converter 16 is exemplarily shown in FIG. 12, it is understood that the converter 16 may include a writing converter for magnetizing the disk 12 and a separate reading converter for sensing the magnetic field of the disk 12. The reading converter is formed of a magneto-resistive element. The converter 16 is typically referred to as a head.

The converter 16 may be integrated with a slider 20. The slider 20 has a structure that forms an air bearing between the converter 16 and a surface of the disk 12. The slider 20 is coupled to a head gimbal assembly 22. The head gimbal assembly 22 is attached to an actuator arm 24 which has a voice coil 26. The voice coil 26 is disposed adjacent to a magnetic assembly 28 so as to form a voice coil motor (VCM) 30. A current supplied to the voice coil 26 generates torque through which the actuator arm 24 is rotated with respect to a bearing assembly 32. Rotation of the actuator arm 25 will move the converter 16 across the surface of the disk 12.

Information is typically stored within an annular track of the disk 12. Each track 34 typically includes a plurality of sectors. Each sector includes a data field and an identification field. An identification field specified in Gray code is used for identifying a sector and a track (cylinder). In the HDD 1100A, a logic block address is converted to cylinder/head/sector information to designate a recording area of the disk 12. The converter 16 is moved across the surface of the disk 12 to read information from another track or write information to another track.

Referring to FIG. 11 again, the HDD controller 1110 controls the read/write channel circuit 1120 to read information from the disk 12 or write information to the disk 12 according to a command received from a host device.

The HDD controller 1110 supplies a control signal for controlling motion of the head 16 included in the HDA 1140 and a control signal for driving the spindle motor 14 to the driver 1130.

The driver 1130 applies a driving current to each of the VCM 30 and the spindle motor 14 based on the control signal supplied by the HDD controller 1110. Accordingly, the converter 16 is moved to a target track of the disk 12, and the disk 12 rotates at a target speed.

During a write operation, the read/write channel circuit 1120 converts data received from the host device into a binary data stream that is suitable for a recording channel of the disk 12, and converts the binary data stream into a recording current and writes the recording current to the disk 12 by using the converter 16.

During a reading operation, the read/write channel circuit 1120 amplifies an electrical signal read from a sector position of a target track of the disk 12 by using the converter 16, encodes the amplified electrical signal into a digital signal, converts the digital signal to stream data and outputs the stream data to the host device.

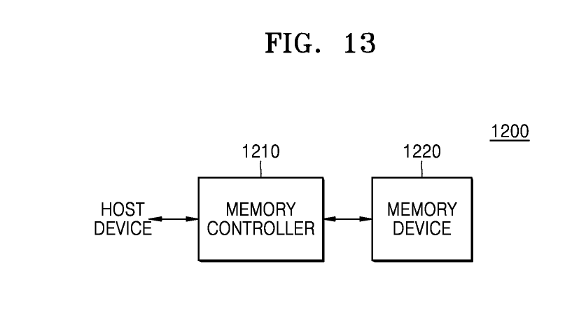

FIG. 13 illustrates the cache storage device 1200 illustrated in FIG. 1 according to an exemplary embodiment.

As illustrated in FIG. 13, the cache storage device 1200 includes a memory controller 1210 and a memory device 1220.

The memory device 1220 may be implemented as a non-volatile memory device. For example, the memory device 1220 may be a flash memory device, a phase change RAM (PRAM) device, a ferroelectric RAM (FRAM) device, or a magnetic RAM (MRAM) device. It is understood that the memory device 1220 may also be implemented as other types of volatile and non-volatile memories, according to other exemplary embodiments.

The memory controller 1210 controls the overall operations of the cache storage device 1200. The memory controller 1210 performs an operation of writing data to the memory device 1220 or reading data from the memory device 1220 according to a command received from a host device.

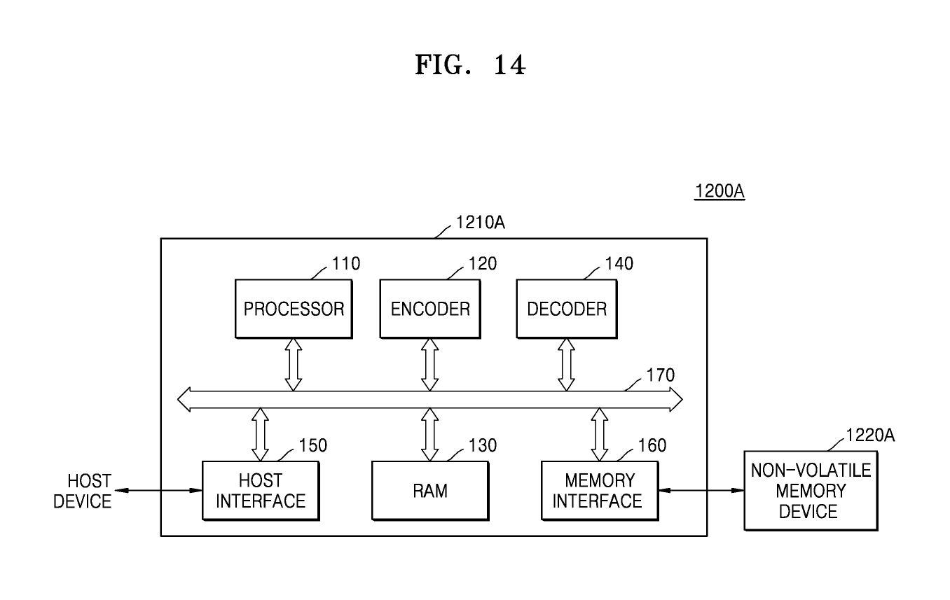

FIG. 14 illustrates a detailed structure of the cache storage device 1200 of FIG. 1 implemented as an SSD 1200A according to an exemplary embodiment.

As illustrated in FIG. 14, the SSD 1200A includes a memory controller 1210A and a non-volatile memory device 1220A.

The memory controller 1210A includes a processor 110, an encoder 120, a RAM 130, a decoder 140, a host interface 150, a memory interface 160, and a bus 170.

The processor 110 is electrically connected to the encoder 120, the RAM 130, the decoder 140, the host interface 150, and the memory interface 160 via the bus 170.

The bus 170 performs the function of transmitting information between other elements (e.g., the processor 110, the encoder 120, the RAM 130, the decoder 140, the host interface 150, and the memory interface 160) of the memory controller 1210A.

The processor 110 controls the overall operations of the SSD 1200A. In detail, the processor 110 deciphers a command received from the host device and controls the SSD 1200A to perform an operation according to a deciphering result.

The processor 110 may provide a read command and an address to the non-volatile memory device 1220A during a reading operation, and may provide a write command, an address, and data to the non-volatile memory device 1220A during a writing operation.

The RAM 130 may temporarily store data received from the host device and data processed in the memory controller 1210A, or data read from the non-volatile memory device 1220A. Also, metadata read from the non-volatile memory device 1220A may be stored in the RAM 130. The RAM 130 may be a DRAM, an SRAM, or the like.

The encoder 120 compresses data received from the host device, generates an error correction code or performs additional processing on the data and then outputs the data to the memory interface 160.

The decoder 140 performs decoding of the data read from the non-volatile memory device 1220A. For example, the decoder 140 performs error detection or correction with respect to the data read from the non-volatile memory device 1220A or restores the compressed data, and then outputs the restored data through the host interface 150.

The host interface 150 operates according to a data exchange protocol which is a technique of exchanging data with a host device that accesses the SSD 1200A, and connects the SSD 1200A and the host device to each other. The host interface 150 may be an Advanced Technology Attachment (ATA) interface, a Serial Advanced Technology Attachment (SATA) interface, a Parallel Advanced Technology Attachment (PATA) interface, a Universal Serial Bus (USB), a Serial Attached Small Computer System (SAS) interface, a Small Computer System Interface (SCSI), an embedded Multi Media Card (eMMC) interface, or a Unix File System (UFS) interface, but is not limited thereto. In detail, the host interface 150 may transmit a command or an address or data with the host device according to control of the processor 110.

The memory interface 160 is electrically connected to the non-volatile memory device 1220A. The memory interface 160 may be formed to support an interface with respect to a NAND flash memory chip or a NOR flash memory chip. The memory interface 160 may be formed such that software and hardware interleave operations are selectively performed through a plurality of channels.

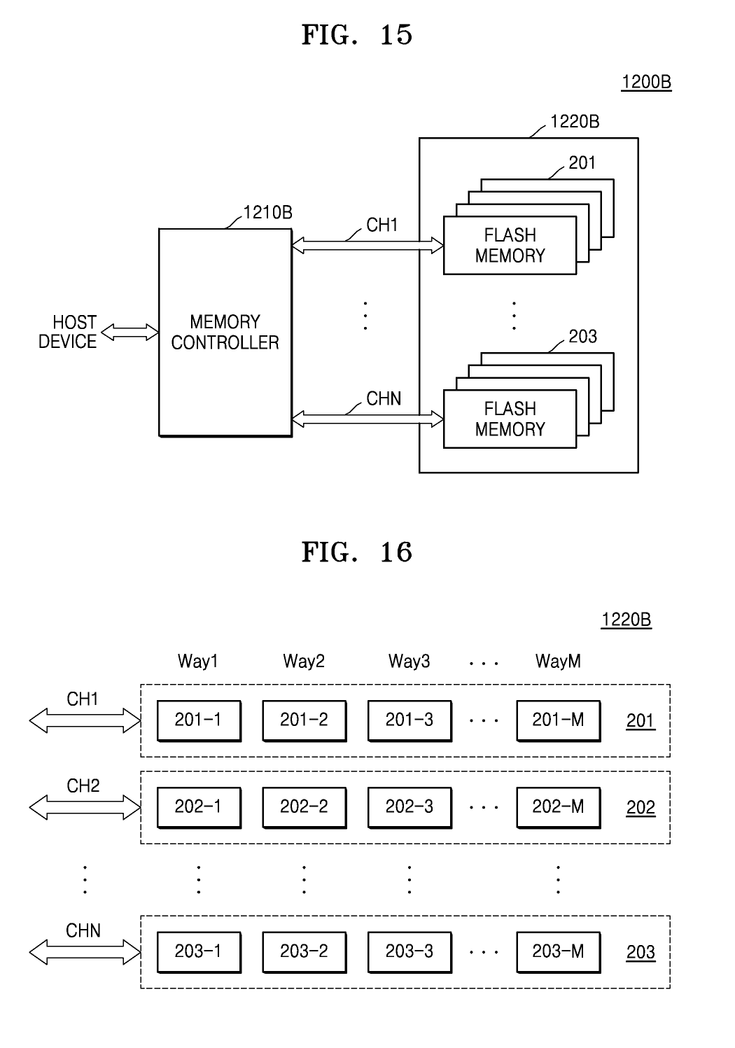

FIG. 15 illustrates a detailed structure of the cache storage device 1200 of FIG. 1 according to an exemplary embodiment.

More specifically, FIG. 15 is a structural diagram of the SSD 1200B including a plurality of channels and ways formed as the non-volatile memory device 1220A illustrated in FIG. 14.

Referring to FIG. 15, the SSD 1200B is a non-volatile memory device 1220B formed of a plurality of flash memory chips 201 and 203.

The SSD 1200B includes N channels (where N is a natural number), and, according to an exemplary embodiment, each channel is formed of four flash memory chips. However, the number of flash memory chips forming each channel may vary according to other exemplary embodiments.

The structure of the memory controller 1210B illustrated in FIG. 15 is substantially the same as the structure of the memory controller 1210A illustrated in FIG. 14, and thus a repeated description thereof will be omitted.

FIG. 16 illustrates details of the SSD 1200B illustrated in FIG. 15 including channels and ways according to an exemplary embodiment.

A plurality of memory chips 201, 202, and 203 may be electrically connected to each of the channels CH1 through CHN. Each of the channels CH1 through CHN may refer to an independent bus through which commands, addresses, and data may be transmitted or received to or from the corresponding flash memory chips 201, 202, and 203. Flash memory chips that are connected to different channels may operate independently. The plurality of flash memory chips 201, 202, and 203 that are connected to each channel may form a plurality of ways Way1 through WayM. M flash memory chips may be connected to M ways formed in each channel.

For example, the flash memory chip 201 may be provided plurally as flash memory chips 201-1 through 201-M and form M ways, Way1 through WayM, in a channel CH1. Flash memory chips 201-1 through 201-M may be connected to the M ways Way1 through WayM of the channel CH1, respectively. The manner in which the flash memory chips 201-1 through 201-M are respectively connected to the M ways Way1 through WayM of the channel CH1 may also apply to the flash memory chips 202 and the flash memory chips 203.

A way is a unit for distinguishing flash memory chips that share the same channel. Each of the flash memory chips may be identified according to a channel number and a way number. A flash memory chip that is connected to a way of a particular channel and in which a request provided by a host is to be performed may be determined by a logical address transmitted from the host.

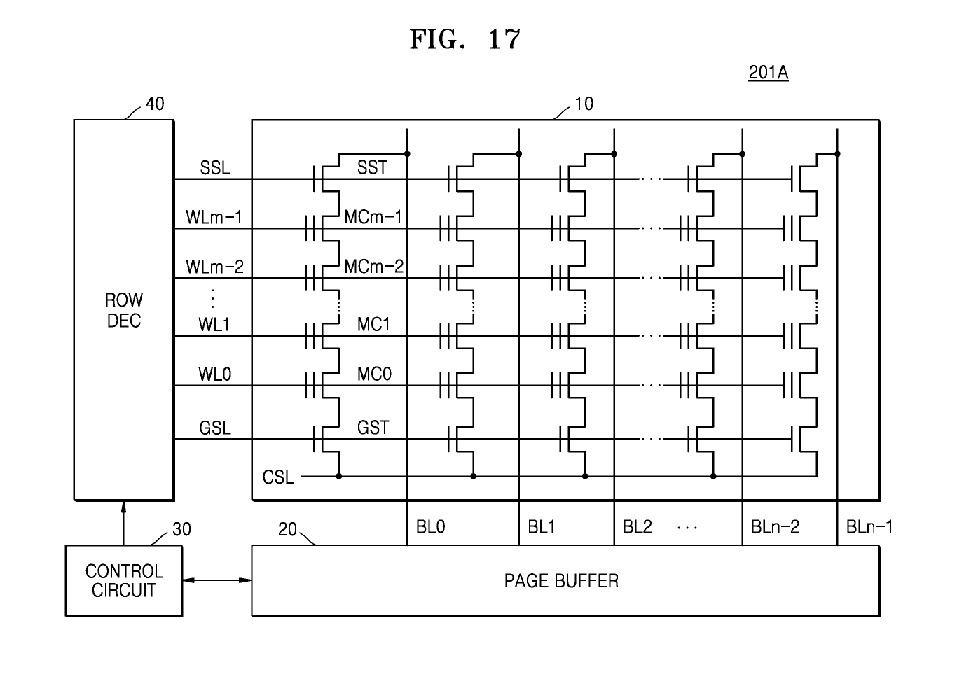

FIG. 17 illustrates a detailed structure of a flash memory chip 201A included in the non-volatile memory device 1220B illustrated in FIG. 16 according to an exemplary embodiment.

As illustrated in FIG. 17, the flash memory chip 201A may include a cell array 10, a page buffer 20, a control circuit 30, and a row decoder 40.

The cell array 10 is an area to which data is written by applying a predetermined voltage to a transistor. The cell array 10 includes memory cells at portions where word lines WL0 through WLm-1 and bit lines BL0 through BLn-1 cross each other. Here, m and n are natural numbers. Although a single memory block is illustrated in FIG. 17, the cell array 10 may include a plurality of memory blocks. Each of the memory blocks includes pages respectively corresponding to the word lines WL0 through WLm-1. Each of the pages includes a plurality of memory cells respectively connected to the word lines WL0 through WLm-1. The flash memory chip 201A performs erasing in block units, and performs programming or reading in page units.

The memory cell array 10 has a cell string structure. Each cell string includes a string selection transistor SST connected to a string selection line SSL, a plurality of memory cells MC0 through MCm-1 respectively connected to a plurality of word lines WL0 through WLm-1, and a ground selection transistor GST connected to a ground selection line GSL. The string selection transistor SST is connected between a bit line and a string channel (not shown), and the ground selection transistor GST is connected between a string channel (not shown) and a common source line CSL.

The page buffer 20 is connected to the cell array 10 through a plurality of bit lines BL0 through BLn-1. The page buffer 20 may temporarily store data to be written to memory cells connected to a selected word line, or temporarily store data read from memory cells connected to a selected word line.

The control circuit 30 generates various voltages required for programming, reading and erasing data with respect to the flash memory chips 201A, and controls the overall operations of the flash memory chips 201A.

The row decoder 40 is connected to the cell array 10 through the string or ground selection lines SSL and GSL and a plurality of word lines WL0 through WLm-1. The row decoder 40 receives an address during a programming or reading operation, and selects a word line according to an input address. Memory cells, in which programming or reading is to be performed, are connected to the selected word line.

Also, the row decoder 40 applies voltages required for programming or reading data to a selected word line, unselected word lines, and string and ground selection lines SSL and GSL (e.g., programming voltage, pass voltage, read voltage, string select voltage, or a ground select voltage).

Each memory cell may store 1 bit data or data at least two bits in length. A memory cell that stores 1 bit data in each memory cell is referred to as a single level cell (SLC). A memory cell that stores data of at least two bits in length is referred to as a multi level cell (MLC). An SLC has an erase state or a programming state according to a threshold voltage.

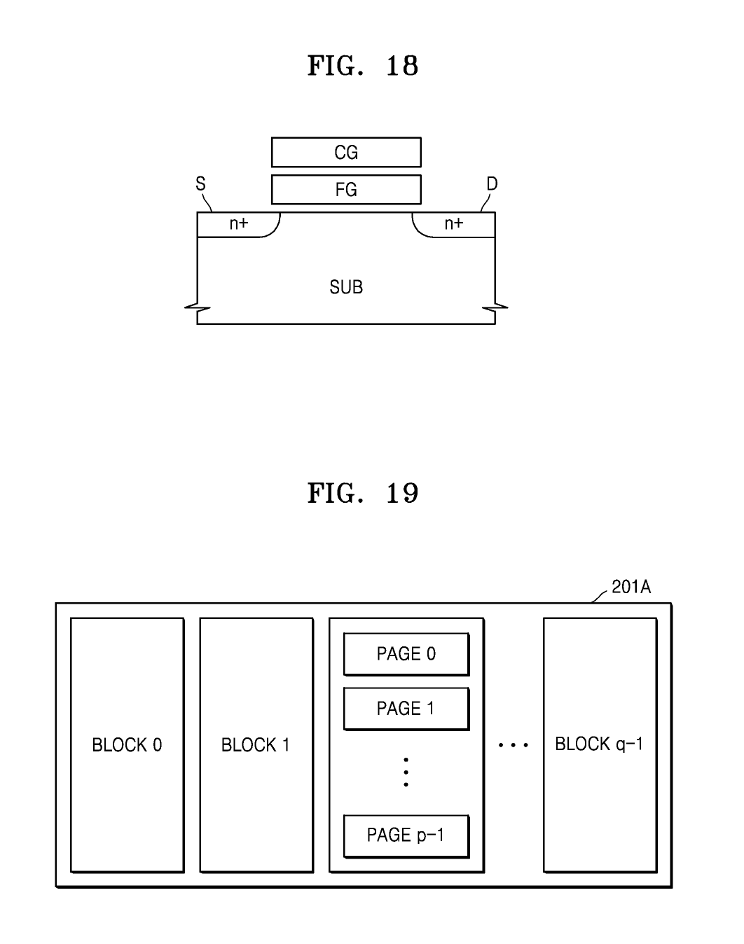

FIG. 18 is a cross-sectional view illustrating a memory cell included in the cell array 10 illustrated in FIG. 17 according to an exemplary embodiment.

Referring to FIG. 18, a source S and a drain D are formed on a substrate SUB, and a channel area may be formed between the source S and the drain D. A floating gate FG is formed on the channel area, and an insulation layer such as a tunneling insulation layer may be disposed between the channel area and the floating gate FG. A control gate CG is formed on the floating gate FG, and an insulation layer such as a blocking insulation layer may be disposed on the floating gate FG. Voltages required for programming, erasing, and reading data with respect to a memory cell MCEL may be applied to the substrate SUB, the source S, the drain D, and the control gate CG.

In the flash memory device, data stored in the memory cell MCEL may be read by distinguishing a threshold voltage Vth of the memory cell MCEL. The threshold voltage Vth of the MCEL may be determined based on the amount of electrons stored in the floating gate FG. In detail, as the number of electrons stored in the floating gate FG increases, the threshold voltage Vth of the memory cell MCEL increases.

FIG. 19 is a conceptual diagram illustrating an internal storage structure of the flash memory chip 201A according to an exemplary embodiment.

As illustrated in FIG. 19, the flash memory chip 201A includes a plurality of blocks, and each of the blocks includes a plurality of pages.

In the flash memory chip 201A, writing and reading of data is performed in page units, and electrical erasing of data is performed in block units. Also, before writing, electrical erasing of a block is required.

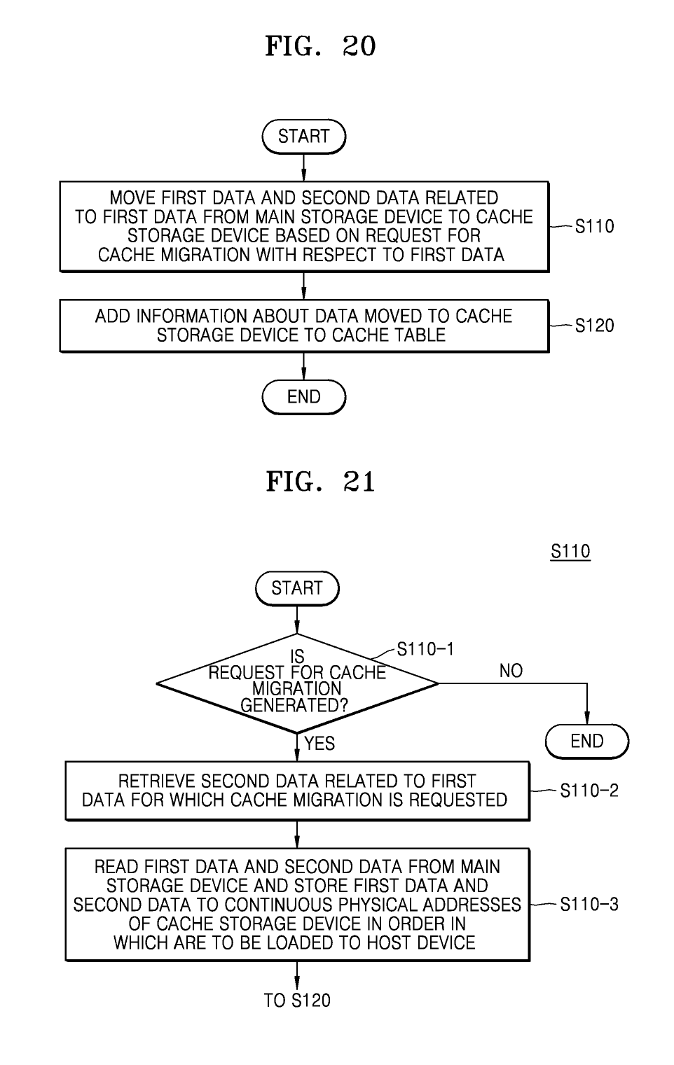

A cache migration management method performed in the host system 10000A or 10000B of FIG. 1 or FIG. 2 according to an exemplary embodiment will be described with reference to FIGS. 20 through 24.

FIG. 20 is a flowchart of a cache migration management method performed in the host system 10000A according to an exemplary embodiment.

In operation S110, the host system 10000A performs an operation of moving first data and second data related to the first data from the main storage device 1100 to the cache storage device 1200 based on a request for cache migration with respect to the first data.

For example, the first and second data moved to the cache storage device 1200 upon the request for cache migration may include file data belonging to the same program installed in the host device 2000A. For example, when an ID is allocated to each program, an operation of moving file data associated with the same ID from the main storage device 1100 to continuous physical addresses of the cache storage device 1200 may be performed based on a request for cache migration with respect to predetermined file data.

For example, the second data may include at least one piece of file data related to the first data. If there is no data related to the first data, an operation of moving the first data to the cache storage device 1200 is performed.

The host system 10000A performs an operation of adding information about data moved to the cache storage device 1200 to a cache table in operation S120. For example, in the cache table, logical addresses of data moved to the cache storage device 1200 and a physical address indicating a storage position in the cache storage device 1200 may be stored.

FIG. 21 is a detailed flowchart of the operation S110 of moving data to the cache storage device 1200 illustrated in FIG. 20 according to an exemplary embodiment.

The host system 10000A determines whether a request for cache migration is generated, at operation S110-1. For example, a request for cache migration is generated when the host system 10000A detects that a condition for storing files of programs of a high access frequency from among programs installed in the host device 2000A is satisfied. A request for cache migration may also be generated by a user's selection. A request for cache migration may further be generated when the host system 10000A is in an idle state.

In operation S110-2, the host system 10000A searches for second data related to the first data for which cache migration is requested. For example, the relevant second data related to the first data may be searched for by using the FA ID table 2205 stored in the host memory 2200A. In the FA ID table 2205, relevant data is associated with the same ID as the first data, and information for designating an access order of data associated with the same ID in a host device is stored.

The host system 10000A performs an operation of reading first data and second data from the main storage device 1100 and storing the first and second data at continuous physical addresses of the cache storage device 1200 according to an order in which the first and second data are to be loaded in the host device 2000A, in operation S110-3.

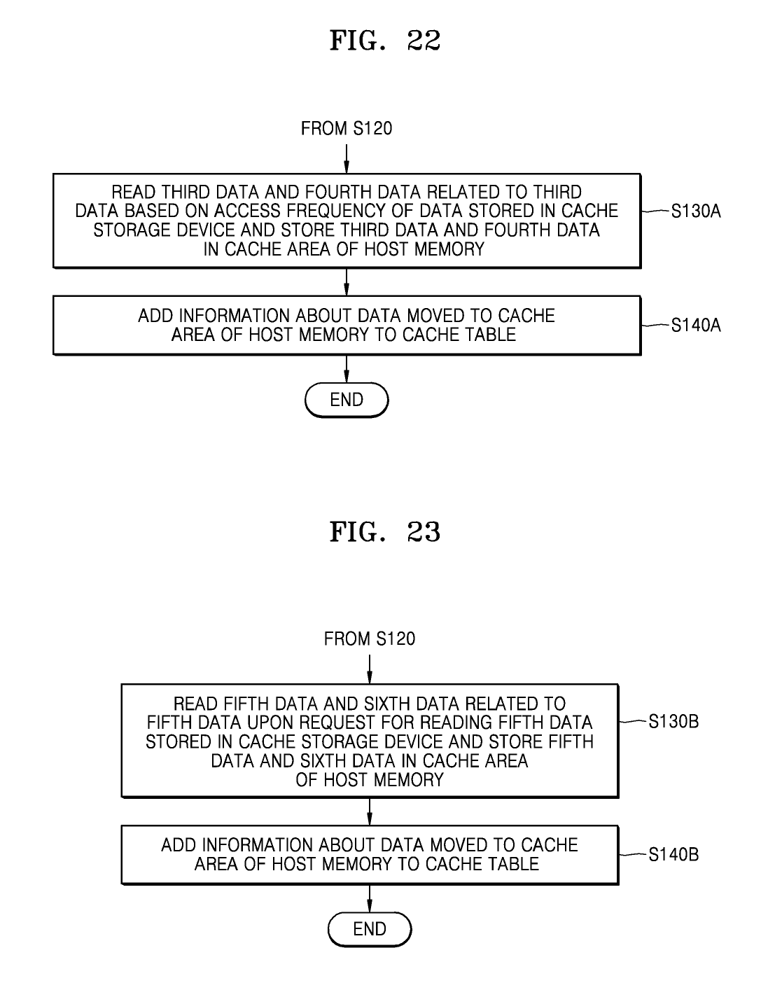

FIG. 22 illustrates an operation of performing cache migration to a cache area of a host memory, according to an exemplary embodiment.

The host system 10000A performs an operation of reading third data and fourth data related to the third data based on an access frequency, from among data stored in the cache storage device 1200, and storing the third data and the fourth data in a cache area of the host memory 2200A in operation S130A. For example, in an idle state, the host system 10000A performs an operation of retrieving third data having an access frequency equal to or higher than a reference value from among data stored in the cache storage device 1200 and fourth data related to the third data, reading the third data and the fourth data, and storing the third data and the fourth data in the cache area of the host memory 2200A. For example, the fourth data may include at least one piece of file data related to the third data. If there is no data related to the third data, an operation of moving the third data to the cache area of the host memory 2200A is performed.

The host system 10000A performs an operation of adding information about data moved to the cache area of the host memory 2200A to the cache table 2206, in operation S140A. For example, logical addresses of the third data and the fourth data and a physical address indicating a storage position of the third data and the fourth data in the cache area of the host memory 2200A are stored in the cache table 2206.

FIG. 23 illustrates an operation of performing cache migration to a cache area of a host memory, according to another exemplary embodiment.

In operation S130B, the host system 10000A performs an operation of reading fifth data and sixth data related to the fifth data upon a request for reading the fifth data stored in the cache storage device 1200 and storing the fifth data and the sixth data in a cache area of the host memory 2200A. For example, the sixth data may include at least one piece of file data related to the fifth data. If there is no data related to the fifth data, an operation of moving the fifth data to the cache area of the host memory 2200A is performed.

In operation S140B, the host system 10000A performs an operation of adding information about data moved to the cache area of the host memory 2200A to a cache table. For example, logical addresses of the fifth data and the sixth data and a physical address indicating a storage position of the fifth data and the sixth data in the cache area of the host memory 2200A are stored in the cache table 2206.

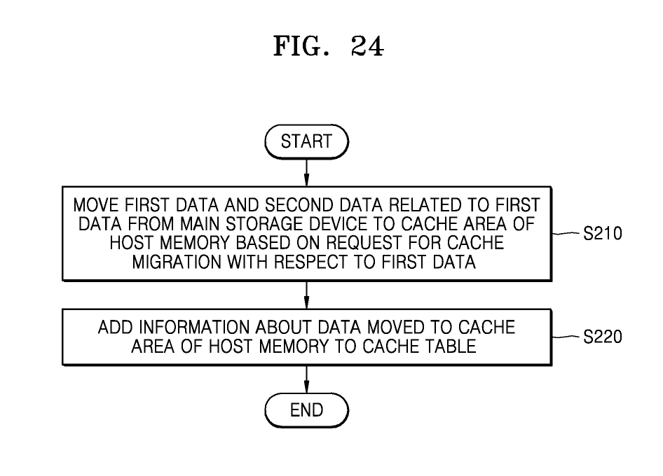

FIG. 24 is a flowchart of a cache migration management method performed in the host system 10000B of FIG. 2 according to another exemplary embodiment.

The host system 10000B performs an operation of moving first data and second data related to the first data based on a request for cache migration with respect to the first data, to the cache area of the host memory 2200B, in operation S210.

For example, the first data and the second data moved to the cache area of the host memory 2200B upon a request for cache migration may include file data belonging to the same program installed in the host device 2000B. For example, when an ID is allocated to each program, an operation of moving the file data associated with the same ID from the main storage device 1100B to continuous physical addresses of the cache area of the host memory 2200B, according to an access order based on a request for cache migration with respect to predetermined file data, may be performed.

For example, the second data may include at least one piece of file data related to the first data. If there is no data related to the first data, an operation of moving the first data to the cache area of the host memory 2200B is performed.

The host system 10000B performs an operation of adding information about data moved to the cache area of the host memory 2200B to the cache table 2206, in operation S220. For example, logical addresses of data moved to the cache area of the host memory 2200B and a physical address indicating a storage position in the cache area of the host memory 2200B may be stored in the cache table 2206.

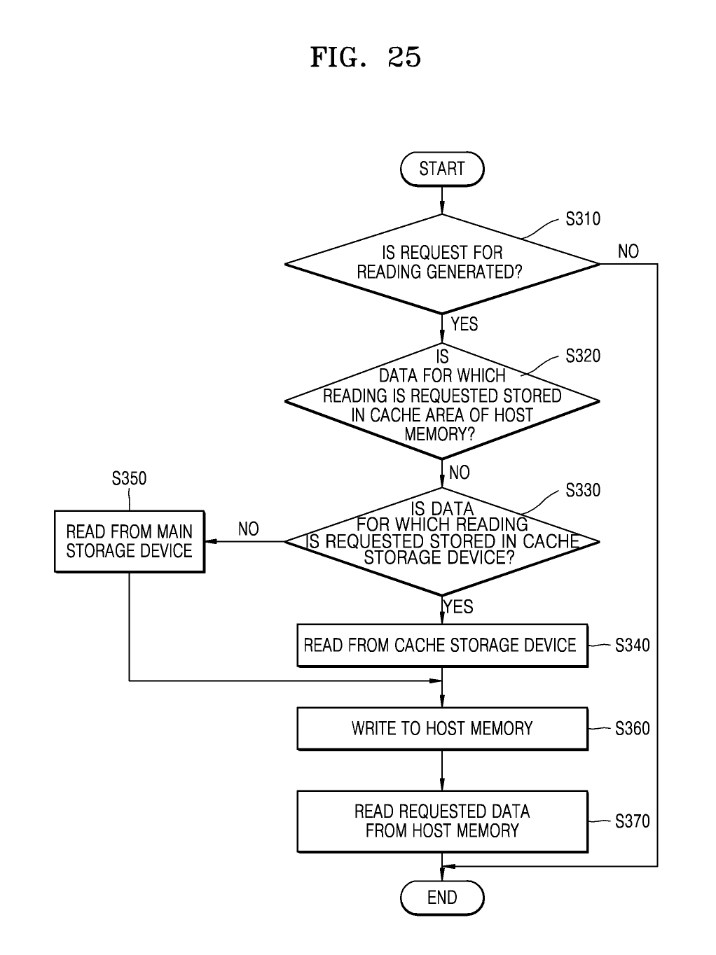

FIG. 25 is a flowchart of a reading operation to be performed by the host system 10000A illustrated in FIG. 1 according to an exemplary embodiment.

In operation S310, the CPU 2100A determines whether a reading request is generated.

If it is determined in operation S310 that a reading request has been generated, then, in operation S320, the CPU 2100A determines whether data for which the reading is requested is stored in the host memory 2200A. For example, by using the cache table 2206, the CPU 2100A may determine whether the data for which the reading is requested is stored in the cache area of the host memory 2200A.

If it is determined in operation S320 that the data for which reading is requested is not stored in the host memory 2200A, then, in operation S330, the CPU 2100A determines whether the data for which the reading is requested is stored in the cache storage device 1200. For example, the CPU 2100A may determine whether the data for which the reading is requested is stored in the cache storage device 1200, by using the cache table 2206.

If it is determined in operation S330 that the data for which the reading is requested is stored in the cache storage device 1200, then, in operation S340, the CPU 2100A performs an operation of reading the requested data from the cache storage device 1200.

If it is determined in operation S330 that the data for which reading is requested is not stored in the cache storage device 1200, then, in operation S350, the CPU 2100A performs an operation of reading the requested data from the main storage device 1100.

In operation S360, the CPU 2100A performs an operation of writing the data read from the main storage device 1100 in operation S350 or the cache storage device 1200 in operation S340 to a general address area of the host memory 2200A.

Next, in operation S370, the CPU 2100A performs an operation of reading the requested data from the cache area or the general address area of the host memory 2200A. The data read from the host memory 2200A is loaded at a target position of the host device 2000A.

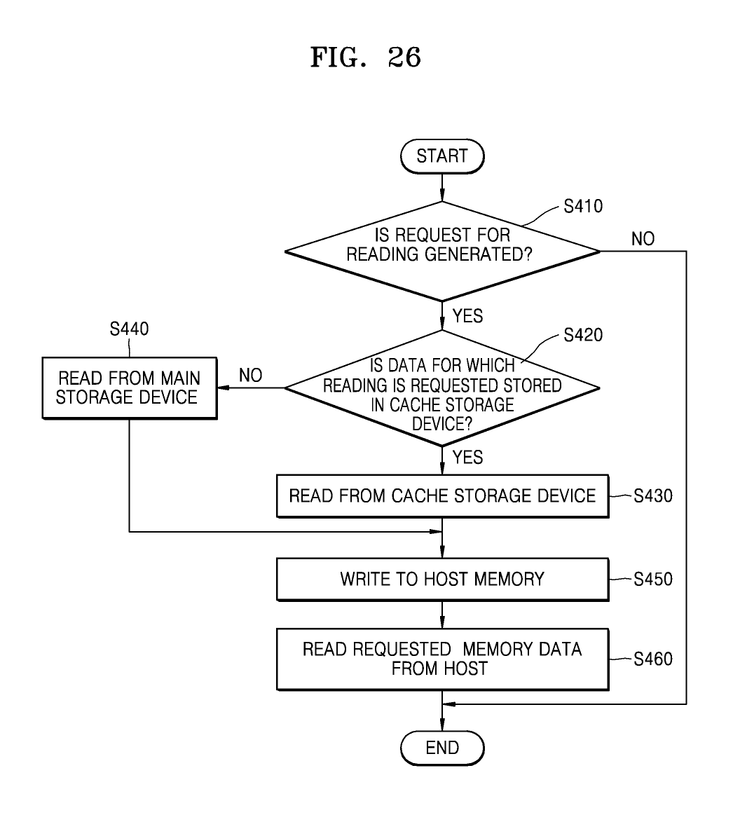

FIG. 26 is a flowchart of a reading operation in the host system 10000A according to another exemplary embodiment.

In operation S410, the CPU 2100A determines whether a reading request is generated.

If it is determined in operation S410 that a reading request has been generated, then, in operation S420, the CPU 2100A determines whether data for which the reading is requested is stored in the cache storage device 1200. For example, by using the cache table 2206, the CPU 2100A may determine whether the data for which the reading is requested is stored in the cache storage device 1200.

If it is determined in operation S420 that data for which the reading is requested is stored in the cache storage device 1200, then, in operation S430, the CPU 2100A performs an operation of reading the requested data from the cache storage device 1200.

If it is determined in operation S420 that data for which the reading is requested is not stored in the cache storage device 1200, then, in operation S440, the CPU 2100A performs an operation of reading the requested data from the main storage device 1100.

In operation S450, the CPU 2100A performs an operation of writing the data read from the cache storage device 1200 or the main storage device 1100 in operation S430 or S440, to the host memory S2200A.

Next, in operation S460, the CPU 2100A performs an operation of reading the requested data from the host memory 2200A. The data read from the host memory 2200A is loaded at a target position of the host device 2000A.

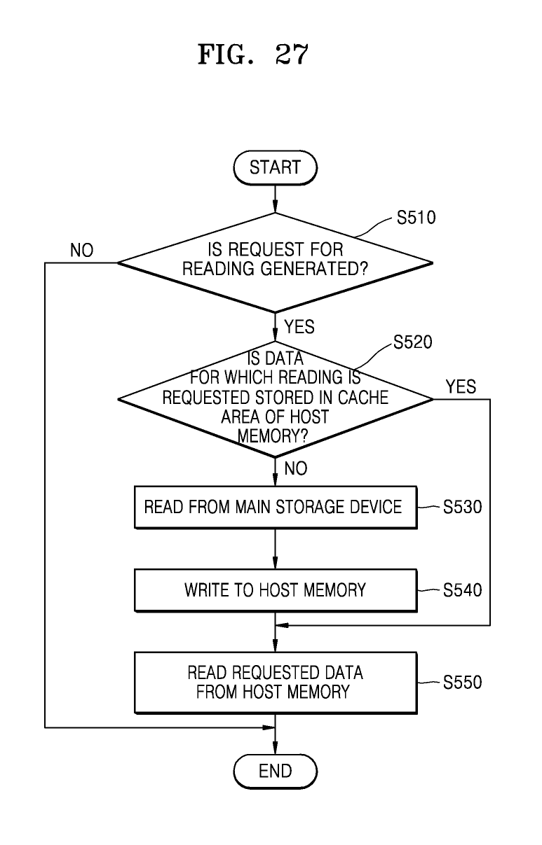

FIG. 27 is a flowchart of a reading operation in the host system 10000B according to an exemplary embodiment.

In operation S510, the CPU 2100B determines whether a reading request is generated.

If it is determined in operation S510 that a reading request has been generated, then, in operation S520, the CPU 2100B determines whether data for which the reading is requested is stored in the cache area of the host memory 2200B. For example, by using the cache table 2206, the CPU 2100B may determine whether the data for which reading is requested is stored in the cache area of the host memory 2200B.

If it is determined in operation S520 that the data for which reading is requested is not stored in the cache area of the host memory 2200B, then, in operation S530, the CPU 2100B performs an operation of reading the requested data from the main storage device 1100B.

In operation S540, the CPU 2100B performs an operation of writing the data read from the main storage device 1100B in operation S530 to a general address area of the host memory 2200A.

Next, in operation S550, the CPU 2100B performs an operation of reading the requested data from the cache area of the host memory 2200B or from the general address area. The data read from the host memory 2200B is loaded at a target position of the host device 2000B.

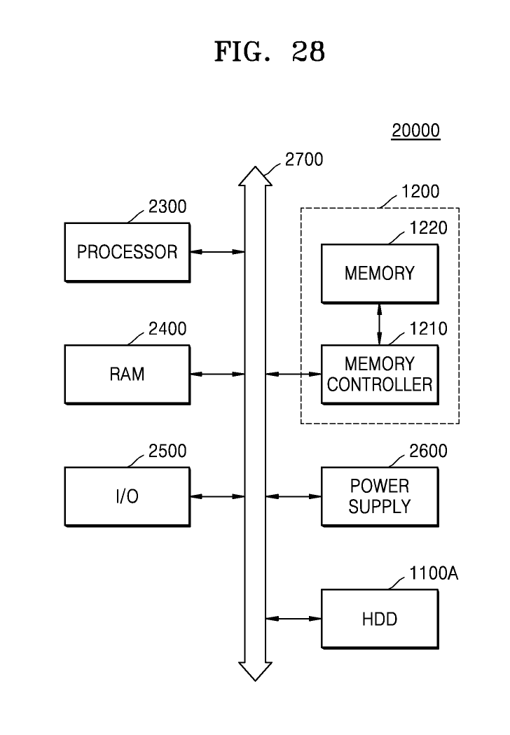

FIG. 28 is a block diagram illustrating an electronic device 20000 configured to perform a cache migration management method according to an exemplary embodiment.

Referring to FIG. 28, the electronic device 20000 includes an HDD 1100A, an SSD 1200, a processor 2300, a RAM 2400, an input/output device 2500, a power supply 2600, and a bus 2700. While not illustrated in FIG. 28, the electronic device 20000 may further include ports through which communication with a video card, a sound card, a memory card, or a USB device or other electronic devices may be performed. The electronic device 20000 may be implemented as a portable electronic device such as a personal computer, a laptop computer, a mobile phone, a PDA, a camera, or numerous other types of electronic devices.

The processor 2300 illustrated in FIG. 28 may be implemented as the CPU 2100A illustrated in FIG. 1, and the RAM 2400 may be implemented as the host memory 2200A illustrated in FIG. 1. Also, the HDD 1100A corresponds to the main storage device, and the SSD 1200 corresponds to the cache storage device.

The processor 2300 may perform predetermined operations or tasks. According to exemplary embodiments, the processor 2300 may be implemented as a micro-processor or a CPU. The processor 2300 may communicate with the RAM 2400, the input/output device 2500, the HDD 1000A, and the SSD 1200 via the bus 2700, which may be implemented as an address bus, a control bus, or a data bus. According to exemplary embodiments, the processor 2300 may also be connected to an extension bus such as a peripheral component interconnect (PCI) bus.

The RAM 2400 may store data needed for operation of the electronic device 2000. For example, the RAM 2400 may be implemented as a DRAM, a mobile DRAM, an SRAM, a PRAM, an FRAM, an RRAM, and/or an MRAM. For example, a portion of a storage area of the RAM 2400 may be allocated as a reserved area. The allocated reserved area may be set as a cache area.

The input/output device 2500 may include an input unit such as a keyboard, a keypad or a mouse, and an output unit such as a display. The power supply 2600 may supply an operating voltage required for operation of the electronic device 20000.

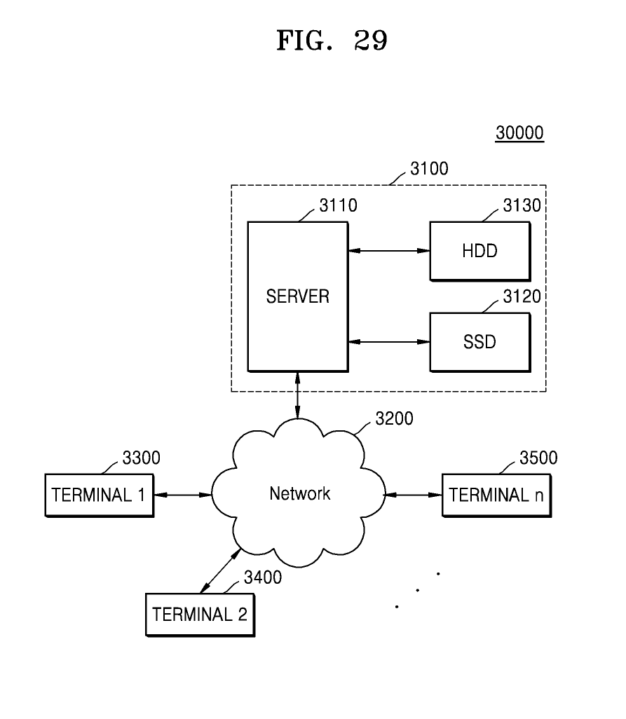

FIG. 29 is a block diagram illustrating a network system 30000 including a server system (3100) configured to perform a cache migration management method according to exemplary embodiments.

Referring to FIG. 29, the network system 30000 includes a server system 3100 and a plurality of terminals 3300, 3400, and 3500 that are connected to each other via a network 3200. The server system 3100 may include a server 3110 that processes a request received from the terminals 3300, 3400, and 3500 connected to the network 3200 and an HDD 3130 and an SSD 3120 that store data corresponding to the request received from the terminals 3300, 3400, and 3500. The server 3100 may include the CPU 2100A and the host memory 2200A illustrated in FIG. 1 as a host device.

The storage device according to the exemplary embodiments may be implemented as a package of various forms. For example, a memory system according to an exemplary embodiment may be mounted by using a package such as a Package on Package (PoP), Ball grid arrays (BGAs), Chip scale packages (CSPs), a Plastic Leaded Chip Carrier (PLCC), a Plastic Dual In-Line Package (PDIP), a Die in Waffle Pack, a Die in Wafer Form, a Chip On Board (COB), a Ceramic Dual In-Line Package (CERDIP), a Plastic Metric Quad Flat Pack (MQFP), a Thin Quad Flatpack (TQFP), a Small Outline (SOIC), a Shrink Small Outline Package (SSOP), a Thin Small Outline (TSOP), a Thin Quad Flatpack (TQFP), a System In Package (SIP), a Multi Chip Package (MCP), a Wafer-level Fabricated Package (WFP), or a Wafer-Level Processed Stack Package (WSP).

While the disclosure has been particularly shown and described with reference to exemplary embodiments thereof, it will be understood that various changes in form and details may be made therein without departing from the spirit and scope of the exemplary embodiments, as defined by the following claims.

What is claimed is:

1. A cache memory management method comprising:
moving, in response to a request for cache migration with respect to first data stored in a main storage device, the first data and second data related to the first data from the main storage device to a cache storage device; and
adding information about the first data moved to the cache storage device and the second data moved to the cache storage device,
wherein the moving of the first data and the second data to the cache storage device comprises storing the first data moved to the cache storage device and the second data moved to the cache storage device at continuous physical addresses of the cache storage device in an order in which the first data and the second data are to be loaded to a host device.

2. The cache memory management method of claim 1, wherein the moving of the first data and the second data to the cache storage device comprises adjusting a writing position such that start positions of the first data and the second data are aligned with a page start position of the cache storage device.

3. The cache memory management method of claim 1, wherein the first data and the second data comprise file data belonging to a same program installed in the host device.

4. The cache memory management method of claim 1, further comprising generating the request for the cache migration based on an access frequency with respect to the first data stored in the main storage device.

5. The cache memory management method of claim 1, further comprising:
reading third data and fourth data related to the third data based on access frequencies of the third data, the third data and the fourth data being stored in the cache storage device; and
storing the third data and the fourth data in an initially allocated cache area of the host device.

6. The cache memory management method of claim 1, further comprising, in response to generating a request for reading fifth data from among data stored in the cache storage device, reading the fifth data and sixth data related to the fifth data from the cache storage device and storing the fifth data and the sixth data in an initially allocated cache area of the host device.

7. The cache memory management method of claim 1, wherein the storing comprises storing, in the cache table, a logical address of the first data and the second data stored in the cache storage device and a physical address of the cache storage device.

8. A host system comprising:
a main storage device configured to store data;
a host memory configured to store the data when the data is read from the main storage device; and
a central processor configured to migrate first data and second data related to the first data, among the data stored in the main storage device, from the main storage device to a cache area of the host memory, based on a request for cache migration with respect to the first data, according to an access order indicating an order in which the first data and the second data are to be loaded to the host memory.

9. The host system of claim 8, wherein, in response to a request for reading the first data and the second data stored in the cache area of the host memory, the central processor is configured to perform an operation of reading the first data and the second data from the cache area of the host memory.

10. The host system of claim 8, further comprising a cache storage device configured to store data selected from among data stored in the main storage device,
wherein, in response to the request for the cache migration with respect to the first data stored in the main storage device, the central processor is configured to perform an operation of moving the first data and the second data related to the first data from the main storage device to continuous physical addresses of the cache storage device.

11. The host system of claim 10, wherein the main storage device and the cache storage device comprise non-volatile storage devices, and the cache storage device has a higher access speed than an access speed of the main storage device.

12. The host system of claim 10, wherein the main storage device comprises a hard disk drive, and the cache storage device comprises a solid state drive.

13. The host system of claim 10, wherein the central processor is configured to adjust a writing position such that a start position of the first data and a start position of the second data are aligned with a page start position of the cache storage device.

14. The host system of claim 10, wherein the central processor is configured to perform an operation of reading third data and fourth data related to the third data based on an access frequency of the third data, the third data and the fourth data being stored in the cache storage device, and to store the third data and the fourth data in an initially allocated cache area of the host memory.

15. The host system of claim 10, wherein in response to a request for reading fifth data from among the data stored in the cache storage device being generated, the central processor is configured to perform an operation of reading the fifth data and sixth data related to the fifth data from the cache storage device and storing the fifth data and the sixth data in an initially allocated cache area of a host memory.

16. A storage system to be used in an electronic apparatus, comprising:
a host memory configured to store first data and second data which is distinct from the first data;
a cache configured to store the first data and the second data in response to a request to migrate the first data from the storage device to the cache; and
a central processor configured to control the cache to store the first data and the second data at continuous physical addresses of the cache according to a relationship between the first data and the second data.

17. The storage system of claim 16, wherein in response to determining that the first data is related to the second data, the central processor controls the cache to store the first data and the second data at the continuous physical addresses.

18. The storage system of claim 17, further comprising a table configured to store information indicating respective IDs of the first data and the second data,
wherein the central processor is configured to determine whether the first data is related to the second data based on whether the first data and the second data are associated with same ID.

19. The storage system of claim 18, wherein the host memory comprises a cache area, and wherein the central processor is further configured to store the first data and the second data in the cache area according to a frequency at which the first data and the second data are accessed.

20. The storage system of claim 19, wherein the request to migrate the first data is automatically generated in response to determining that the storage system is in an Idle state.
